(19) United States
(12) Patent Application Publication
(10) Pub. No.: US 2026/0030829 A1
(43) Pub. Date: Jan. 29, 2026

(54) INFORMATION PROCESSING

(71) Applicant: TENCENT TECHNOLOGY (SHENZHEN) COMPANY LIMITED, Shenzhen (CN)

(72) Inventors: Hu WANG, Shenzhen (CN); Zhenyu LI, Shenzhen (CN)

(73) Assignee: TENCENT TECHNOLOGY (SHENZHEN) COMPANY LIMITED, Shenzhen (CN)

(21) Appl. No.: 19/347,514

(22) Filed: Oct. 1, 2025

Related U.S. Application Data
(63) Continuation of application No. PCT/CN2024/117406, filed on Sep. 6, 2024.

(30) Foreign Application Priority Data
Sep. 25, 2023 (CN) 202311252325.4

(51) Int. Cl. G06T 15/04; A63F 13/52; A63F 13/63

(52) U.S. Cl. CPC G06T 15/04; A63F 13/52; A63F 13/63; A63F 2300/308; A63F 2300/66

(57) ABSTRACT

In an information processing method, a virtual object is displayed in an editing preview area of a user generated content (UGC) editing interface of a game program. A skin of the virtual object corresponds to a collection of surface visible attributes of the virtual object. In the method, at least one changer, configured to define a skin change process of the skin in a game process, is displayed in an editing control area of the UGC editing interface. In the method, a skin parameter corresponding to one of the surface visible attributes in the skin change process is set based on a parameter editing operation of a skin parameter editing control element of the changer. In the method, the virtual object based on execution of the skin change process is displayed in the editing preview area.

### RELATED APPLICATIONS

The present application is a continuation of International Application No. PCT/CN2024/117406, filed on Sep. 6, 2024, which claims priority to Chinese Patent Application No. 202311252325.4, filed on Sep. 25, 2023, and entitled “METHOD AND APPARATUS FOR GENERATING UGC IN GAME PROGRAM, DEVICE, AND STORAGE MEDIUM.” The entire disclosures of the prior applications are hereby incorporated by reference.

### FIELD OF THE TECHNOLOGY

This disclosure relates to the field of games, including an information processing method and apparatus, a device, and a storage medium.

### BACKGROUND OF THE DISCLOSURE

User generated content (UGC) refers to self-created content shared by users on the Internet. In the field of games, a designer encourages a user to participate in the design of game content such as a level map, gameplay, and an ecosystem by providing a corresponding UGC editing capability in a game. When designing the level map, the user usually wants to change an appearance of a virtual item, to enrich interface representation and increase the playability of one or more gaming levels.

In a related technology, a color parameter interface of a skin of a virtual item is open to (and hence becomes configurable by) the user. The user may change a skin color of the virtual item in a UGC editor by editing corresponding parameters of the skin of the virtual item based on operating a color parameter control.

In the foregoing solution, the user can only adjust the color of the skin, and adjustment of the skin of the virtual item is still very limited. The user cannot fully use existing skin resources, resulting in resource waste.

### SUMMARY

According to embodiments of this disclosure, an information processing method is provided. In the method, a virtual object in a virtual environment is displayed, by processing circuitry, in an editing preview area of a user generated content (UGC) editing interface of a game program based on execution of the game program. A skin of the virtual object corresponds to a collection of surface visible attributes of the virtual object. In the method, at least one changer, configured to define a skin change process of the skin of the virtual object in a game process, is displayed by the processing circuitry in an editing control area of the UGC editing interface. In the method, a skin parameter corresponding to one of the surface visible attributes of at least one target state in the skin change process is set based on a parameter editing operation of a skin parameter editing control element of the changer. In the method, the virtual object based on execution of the skin change process defined by the changer is displayed in the editing preview area.

According to embodiments of this disclosure, an information processing apparatus is provided. The apparatus includes processing circuitry configured to display, in an editing preview area of a user generated content (UGC) editing interface of a game program based on execution of the game program, a virtual object in a virtual environment. A skin of the virtual object corresponds to a collection of surface visible attributes of the virtual object. The processing circuitry is configured to display, in an editing control area of the UGC editing interface, at least one changer configured to define a skin change process of the skin of the virtual object in a game process. The processing circuitry is configured to set a skin parameter corresponding to one of the surface visible attributes of at least one target state in the skin change process based on a parameter editing operation of a skin parameter editing control element of the changer. The processing circuitry is configured to display, in the editing preview area, the virtual object based on execution of the skin change process defined by the changer.

According to embodiments of this disclosure, a non-transitory computer-readable storage medium is provided. The non-transitory computer-readable storage medium stores instructions, which when executed by a processor, cause the processor to perform displaying, in an editing preview area of a user generated content (UGC) editing interface of a game program based on execution of the game program, a virtual object in a virtual environment. A skin of the virtual object corresponds to a collection of surface visible attributes of the virtual object. The instructions, when executed by the processor, cause the processor to perform displaying, in an editing control area of the UGC editing interface, at least one changer configured to define a skin change process of the skin of the virtual object in a game process. The instructions, when executed by the processor, cause the processor to perform setting a skin parameter corresponding to one of the surface visible attributes of at least one target state in the skin change process based on a parameter editing operation of a skin parameter editing control element of the changer. The instructions, when executed by the processor, cause the processor to perform displaying, in the editing preview area, the virtual object based on execution of the skin change process defined by the changer.

According to embodiments of this disclosure, an information processing method is provided. The method includes: displaying a virtual item that is located in a virtual environment and that has a skin in the editing preview area, and displaying a skin parameter editing control of at least one changer in the editing control area, the changer being configured to edit a skin change process of the virtual item in a game process; editing a skin parameter of at least one target state in the skin change process in response to a parameter editing operation for a skin parameter editing control of the changer; and displaying, in the editing preview area, the skin change process of the changer executed on the virtual item, the skin being a collection of surface visible attributes of the virtual item.

One or more embodiments of this disclosure further provide an information processing apparatus. The apparatus includes: a display module, configured to display a virtual item that is located in a virtual environment and that has a skin in an editing preview area, and display a skin parameter editing control of at least one changer in an editing control area, the changer being configured to edit a skin change process of the virtual item in a game process; an editing module, configured to edit a skin parameter of at least one target state in the skin change process in response to a parameter editing operation for a skin parameter editing control of the changer; and the display module, configured to display, in the editing preview area, the skin change process of the changer executed on the virtual item, the skin being a collection of surface visible attributes of the virtual item.

One or more embodiments of this disclosure further provide a computer device. The computer device includes processing circuitry such as a processor and includes a memory. The memory includes a non-transitory computer-readable storage medium that has a computer program or instructions stored therein. The computer program or instructions are loaded and executed by the processor to implement the foregoing information processing method.

One or more embodiments of this disclosure further provide a non-transitory computer-readable storage medium, which has a computer program or instructions stored therein. The computer program or instructions are executed by the processor to implement the foregoing information processing method.

One or more embodiments of this disclosure further provide a computer program product. The computer program product includes a computer program. The computer program is stored in a non-transitory computer-readable storage medium. The computer program is read and executed by a processor of a computer device from the non-transitory computer-readable storage medium, to enable the computer device to perform the foregoing information processing method.

### BRIEF DESCRIPTION OF THE DRAWINGS

To describe technical solutions of one or more embodiments of this disclosure, the following briefly introduces drawings of one or more embodiments. The accompanying drawings in the following description show only some non-limiting embodiments of this disclosure. Other embodiments are within the scope of the disclosure.

FIG. 1 is a schematic diagram of an interface of a method for generating UGC in a related technology.

FIG. 2 is a schematic diagram of an interface of a method for generating UGC in a related technology.

FIG. 3 is a schematic diagram of an interface of a method for generating UGC in a related technology.

FIG. 4 is a schematic diagram of an interface of a method for generating UGC according to an embodiment of this disclosure.

FIG. 5 is a schematic diagram of an interface of a method for generating UGC according to an embodiment of this disclosure.

FIG. 6 is a schematic diagram of an interface of a method for generating UGC according to an embodiment of this disclosure.

FIG. 7 is a schematic diagram of an interface of a method for generating UGC according to an embodiment of this disclosure.

FIG. 8 is a schematic diagram of an interface of a method for generating UGC according to an embodiment of this disclosure.

FIG. 9 is a schematic diagram of an interface of a method for generating UGC according to an embodiment of this disclosure.

FIG. 10 is a schematic diagram of a computer system according to an embodiment of this disclosure.

FIG. 11 is a schematic diagram of a computer system according to an embodiment of this disclosure.

FIG. 12 is a flowchart of an information processing method according to an embodiment of this disclosure.

FIG. 13 is a flowchart of an information processing method according to an embodiment of this disclosure.

FIG. 14 is a data structure of an information processing method according to an embodiment of this disclosure.

FIG. 15 is a schematic diagram of texture scaling according to an embodiment of this disclosure.

FIG. 16 is a schematic diagram of a parameter control gradient mode according to an embodiment of this disclosure.

FIG. 17 is a structural block diagram of an information processing apparatus according to an embodiment of this disclosure.

FIG. 18 is a structural block diagram of a computer device according to an embodiment of this disclosure.

### DESCRIPTION OF EMBODIMENTS

To illustrate objectives, technical solutions, and advantages of this disclosure, the following describes non-limiting examples of this disclosure in further detail with reference to the accompanying drawings.

Embodiments are described in further detail herein, and non-limiting examples of embodiments are shown in the accompanying drawings. When the following description involves the accompanying drawings, unless otherwise indicated, the same numerals in different accompanying drawings represent the same or similar elements. The implementations described in the following embodiments do not represent all implementations consistent with this disclosure. On the contrary, the implementations are only non-limiting examples of this disclosure.

Terms used in this disclosure are for the purpose of describing one or more embodiments and are not intended to limit this disclosure. Singular forms of “a”, “the”, and “this” used in this disclosure and the appended claims may be understood as encompassing those elements in plural forms, unless other meanings are indicated in context. The term “and/or” used herein indicates and includes any or all possible combinations of one or more associated listed items.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

First, related terms involved in this disclosure are introduced below. Descriptions of terms in this disclosure are provided as examples only and are not intended to limit the scope of this disclosure.

User generated content (UGC): UGC may correspond to self-created content shared by users on the Internet. In the field of games, a designer encourages a user to participate in the design of game content such as a level map, gameplay, and an ecosystem by providing a corresponding UGC editing capability in a game. By designing the game content by the user, the sense of association of the user to the game and the richness of the game content are improved, and the user's personalized wishes and/or demands may be fulfilled.

Virtual environment: A virtual environment may be displayed (or provided) when a game client runs on a terminal. The virtual environment may be a simulated environment of the real world, a semi-simulated and semi-fictional environment, or a purely fictional environment. The virtual environment may be any one of a two-dimensional virtual environment, a 2.5-dimensional virtual environment, and a three-dimensional virtual environment. This is not limited in this disclosure. The following embodiments are described by using an example in which the virtual environment is a three-dimensional virtual environment.

Virtual item: A virtual item may correspond to a digital object (or virtual object) or item in a virtual environment, and may be configured to enhance playability interest or user experience in a game. The virtual item usually exists in a form of data, code, or another electronic form, and may be used, exchanged, purchased, or sold within a game or in a virtual environment, to implement various functions, effects, or objectives in the game. These virtual items may include equipment, character appearances, in-game currency, cards, skills, or other fictive items.

Skin: A skin may correspond to a collection of surface visible attributes of a virtual item, and may be configured to modify an appearance or visual representation of a virtual character or the virtual item in a game, to enhance user experience or provide a personalized element. The surface visual attributes include at least one of color, texture, smoothness, transparency, reflectivity, refractive index, and emissive intensity of a surface of the virtual item. Various model materials in a game implement image rendering and skin drawing based on a shader.

Draw call: A draw call may correspond to a concept in computer graphics, and may be used to describe a drawing command transmitted by a rendering engine to a graphics processing unit (GPU) each time a scene is rendered. A draw call may correspond to a rendering operation, and may include some information necessary for drawing an image, for example, vertex data, a texture, and a shader program. To draw an object, the rendering engine may transmit a draw call to the GPU. The GPU performs a drawing operation according to information in the draw call. Therefore, each draw call may correspond to an additional workload of the GPU, so a draw call quantity may have a significant impact on the performance of a game. Relatively few draw calls can greatly improve rendering performance of a mobile-end game. This is more significant in mid-to-low-end models with a relatively weak GPU capability.

Batching: Batching may correspond to a common optimization technology. In some aspects, a draw call needs to be submitted every time the rendering engine draws a model, and there may be 100 draw calls for 100 models. The 100 draw calls may be combined to one draw call by batching, to reduce the draw call quantity, and improve rendering efficiency. There may be one or more limitations to batching, where content of a draw call with batching may need to be consistent in terms of shaders, models, textures, primitive parameters, and rendering states.

Dynamic instance: A dynamic instance may correspond to a process of creating an object during running. During graphic rendering, different models or particle objects may be dynamically created according to a user input or game logic in a gameplay process of a user by using the dynamic instance.

GPU scene: A GPU scene may correspond to a mechanism introduced by unreal engine to combine a large quantity of dynamic instances into one rendering to maximize advantages of batching. In this mechanism, a cache area may be configured to store drawing information of each primitive in an entire game scene, and may include additional custom data. Therefore, even instances with inconsistent primitive parameters may be drawn together.

UV coordinates: In a game engine, UV coordinates may correspond to a coordinate system configured to describe texture mapping on a 3D model, and may be configured to map a two-dimensional texture image to a surface of a three-dimensional model, to correctly conform to a texture, and to present a realistic appearance in a rendering process. A U coordinate may represent a transverse (horizontal) coordinate, and a V coordinate may represent a longitudinal (vertical) coordinate. These coordinate values define a position on a texture image, to determine how to apply a texture map to a surface of a model. By allocating UV coordinates on each vertex of the model, the game engine can instruct how a texture is packed or projected on the model, to enable the texture mapping to look realistic and accurate.

Although terms such as “first” and “second” may be used in this disclosure to describe various types of information, the information is not limited to these terms. These terms are merely used to distinguish between information of the same type. For example, without departing from the scope of this disclosure, a first parameter may be referred to as a second parameter, and similarly, the second parameter may be referred to as the first parameter in some embodiments. Depending on context, for example, the word “if” used herein may be interpreted as “while” or “when” or “determining . . . in response to.”

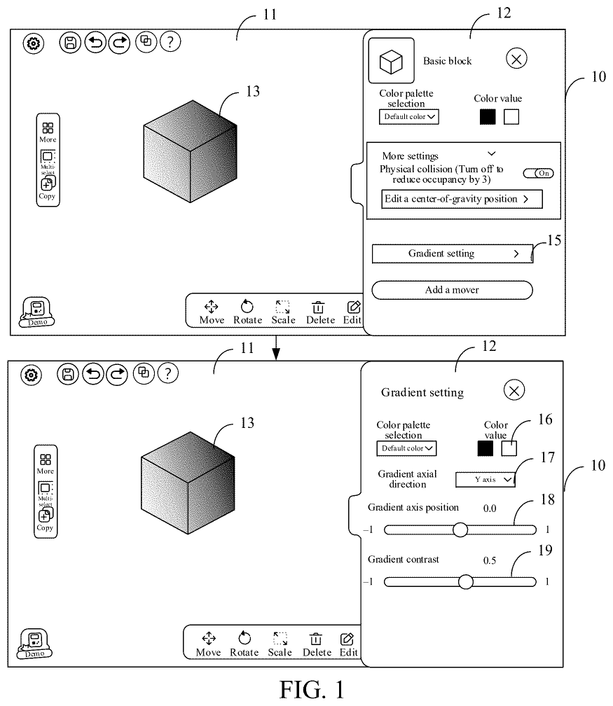

FIG. 1 to FIG. 3 are schematic diagrams of a method for generating UGC in a related technology.

As shown in FIG. 1, a UGC editor interface 10 includes an editing preview area 11 and an editing control area 12. A virtual item 13 that is being edited is displayed in the editing preview area 11. A plurality of controls for editing the virtual item 13 are displayed in the editing control area 12. When a gradient setting is performed on a color of the virtual item 13, by clicking a gradient setting control 15, the editing control area 12 jumps to display an editing control for gradient setting, such as a color 16, a gradient axial direction 17, a gradient axis position 18, and a gradient contrast 19. A user sets a gradient mode of the virtual item 13 by using the foregoing editing control. In some aspects in this disclosure, “editing” or “edit” a parameter may also be referred to as “setting” or “set” the parameter, and may correspond to one or more operations including modifying, creating, and/or deleting the parameter, or the like.

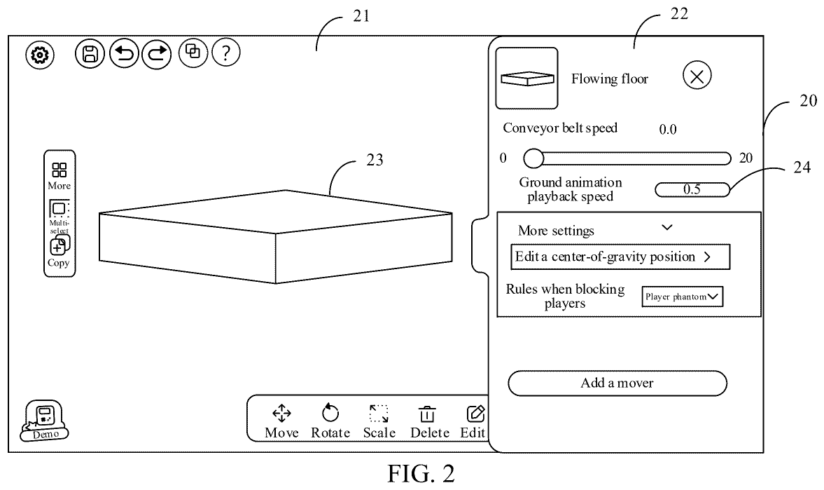

As shown in FIG. 2, a UGC editor interface 20 includes an editing preview area 21 and an editing control area 22. A virtual item 23 that is being edited is displayed in the editing preview area 21, and the virtual item 23 is flowing floor, that is, floor having a flowing effect. A plurality of controls for editing the virtual item 23 are displayed in the editing control area 22. When a ground playback speed of a flowing effect of the virtual item 23 is set, the ground playback speed is adjusted through a ground animation playback speed editing control 24 in the editing control area 22.

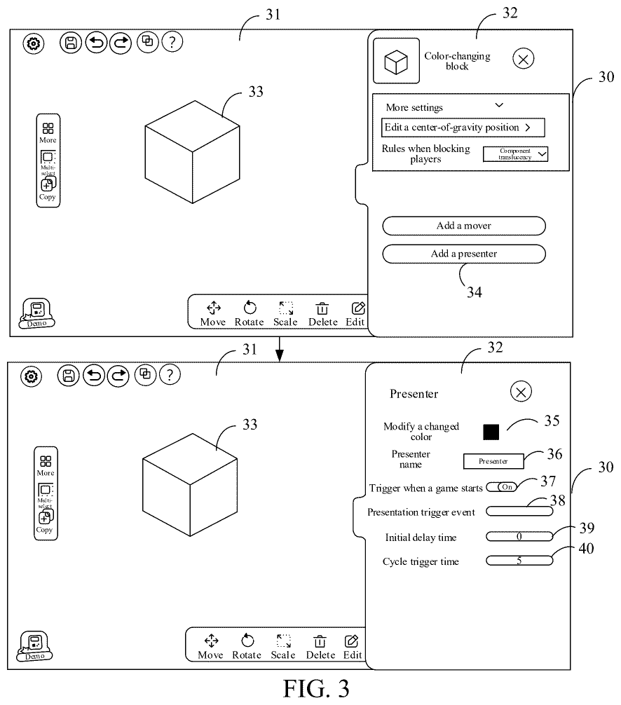

As shown in FIG. 3, a UGC editor interface 30 includes an editing preview area 31 and an editing control area 32. A virtual item 33 that is being edited is displayed in the editing preview area 31, and the virtual item is a color-changing block, that is, a block having a color changing attribute. A plurality of controls for editing the virtual item 33 are displayed in the editing control area 32. When a color changing effect of the virtual item 33 is set, by clicking a presenter adding control 34, the editing control area 32 jumps to display a plurality of controls for editing a color changing effect, for example, a target color modifying editing control 35, a presenter name editing control 36, a game start trigger editing control 37, a presentation trigger event editing control 38, an initial delay time 39, and a cycle trigger time 40. A user sets a color changing effect of the virtual item 33 by using the foregoing editing control. However, the color-changing block can only implement instant color switching with a very single function, which does not involve adjustment of other parameters of a skin, and cannot implement rich presentation effects such as transition switching and flickering. In addition, when a user sets a switched color, a set effect after switching cannot be seen instantly, that is, any effect preview cannot be performed.

It can be learned from FIG. 1 to FIG. 3 that, parameter adjustment of the skin of the virtual item provided in the related technology is only limited to color adjustment, and parameter adjustment of the skin of a dynamic effect is only limited to an animation playback speed. Adjustable skin parameters cover a small scope, and change insufficiently in a game process, which cannot meet a UGC user requirement, does not fully utilize an existing skin resource, and causes a large amount of waste. In addition, in settings involving skin changing, the user cannot preview an effect after changing in real time. In this way, adjustment cannot be performed quickly to achieve a desired effect, and repeated adjustment needs to be performed a plurality of times, which results in low human-computer interaction efficiency.

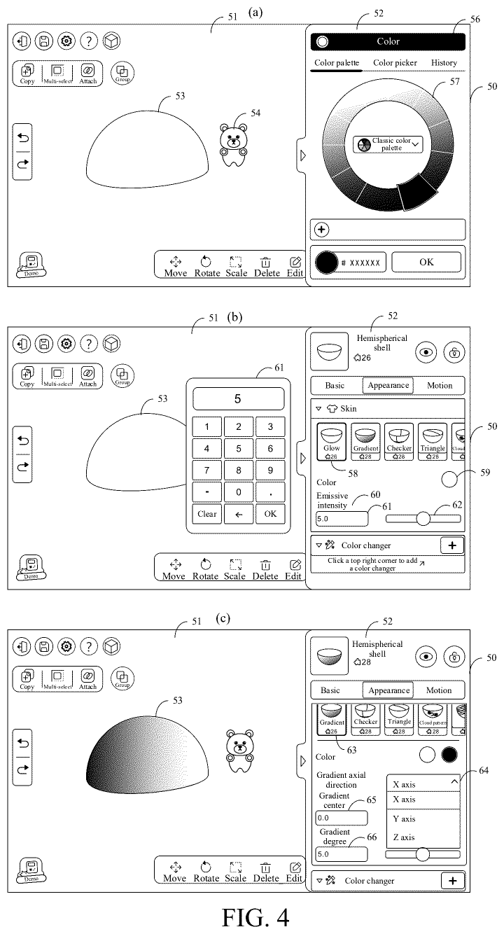

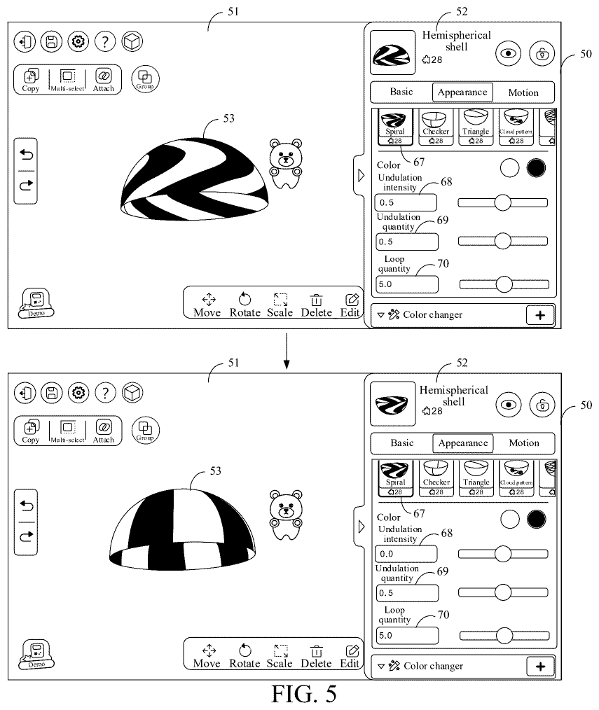

FIG. 4 and FIG. 5 are schematic diagrams of a UGC editor interface for an information processing method according to an embodiment of this disclosure.

As shown in FIG. 4, a UGC editor interface 50 includes an editing preview area 51 and an editing control area 52. A virtual item 53 that is being edited is displayed in the editing preview area 51, and the virtual item is a hemispherical shell. A plurality of controls for editing the virtual item 53 are displayed in the editing control area 52. The editing control area 52 in FIG. 4(a) includes a color editing control 57 for editing a skin color of the virtual item 53, that is, a color palette shown in the figure. The editing control area 52 in FIG. 4(b) includes a skin type editing control for editing a skin type of the virtual item 53 (for example, selecting an emissive skin 58 as the skin type in the figure), and a plurality of editing controls, for example, a color editing control 59 and an emissive intensity editing control 60, for editing a skin according to the emissive skin type. The emissive intensity editing control 60 may edit by using a keyboard input editing control 61 and a slide bar pulling editing control 62. The editing control area 52 in FIG. 4(c) includes a skin type editing control for editing a skin type of the virtual item 53 (for example, selecting a gradient skin 63 as the skin type in the figure), and a plurality of editing controls, for example, a gradient axial direction 64, a gradient center 65, and gradient intensity 66, for editing a skin according to the gradient skin type.

As shown in FIG. 5, a UGC editor interface 50 includes an editing preview area 51 and an editing control area 52. A virtual item 53 that is being edited is displayed in the editing preview area 51, and the virtual item is a hemispherical shell. A plurality of controls for editing the virtual item 53 are displayed in the editing control area 52. The editing control area 52 includes a skin type editing control for editing a skin type of the virtual item 53 (for example, selecting a spiral skin 67 as the skin type in the figure), and a plurality of editing controls, for example, an undulation intensity editing control 68, an undulation quantity editing control 69, and a loop quantity editing control 70, for editing a skin according to the spiral skin type. With adjustment of a skin parameter (for example, an undulation intensity is adjusted from 0.5 to 0.0 in the figure), the virtual item 53 displayed in the editing preview area 52 is changed in real time to an effect obtained after the parameter is adjusted.

It can be known from FIG. 4 and FIG. 5 that, in this technical solution, the user-adjustable skin parameter is uniformly generalized to the “appearance” tab in the editing control area 52. The skin type determines a material used by a virtual item currently selected by the user, and an adjustable parameter that is correspondingly open to the skin is displayed in the editing control area 52 according to the skin. For a value type parameter, two editing modes, that is, slide bar input and keyboard input, are set, and the value type parameter has an upper limit and a lower limit. For an option type parameter, the parameter is changed by using a drop-down box. When the user adjusts a parameter value, with changes of the value of the parameter value, the virtual item 53 in the scene changes to an adjusted effect in real time, whereby the user can quickly adjust the skin of the virtual item 53 to a desired state.

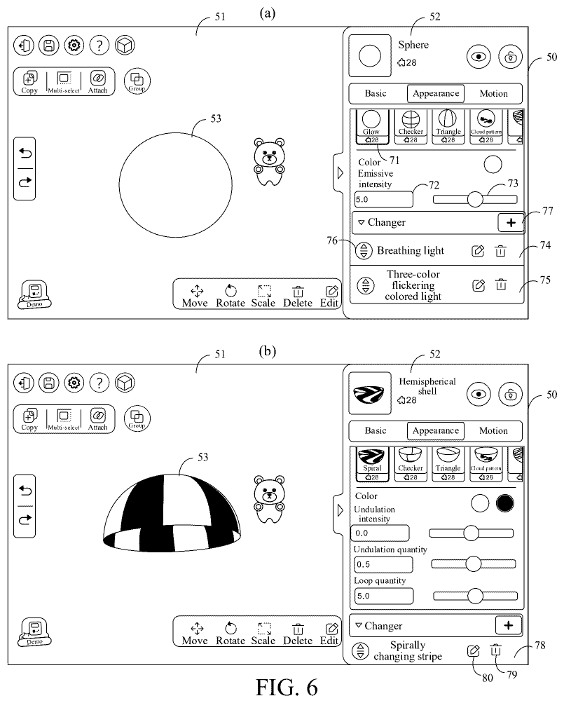

FIG. 6 to FIG. 9 show interface diagrams of a changer in an information processing method according to an embodiment of this disclosure.

As shown in FIG. 6, a UGC editor interface 50 includes an editing preview area 51 and an editing control area 52. As shown in FIG. 6(a), a virtual item 53 that is being edited is displayed in the editing preview area 51, and the virtual item is a sphere. A plurality of controls for editing the virtual item 53 are displayed in the editing control area 52. The editing control area 52 includes a skin type editing control for editing a skin type of the virtual item 53 (for example, selecting an emissive skin 71 as the skin type in the figure), and a plurality of editing controls, for example, emissive intensity, for editing a skin according to the emissive skin type. The emissive intensity may be edited by using a keyboard input editing control 72 and a slide bar pulling editing control 73.

As shown in FIG. 6(a), the editing control area 52 further includes a list of changers (for example, a breathing light changer 74 and a three-color flickering colored light changer 75 shown in the figure). In a case that more than one changer is provided, a top ranked changer has a highest priority, a lower ranked changer indicates a lower priority, and the changers respond and are executed sequentially. A sequence of the breathing light changer 74 and the three-color flickering colored light changer 75 may be adjusted by using a priority adjustment control 76. A changer for the virtual item 53 may be created by clicking a changer adding control 77. As shown in FIG. 6(b), the virtual item 53 is a hemispherical shell, which has a spirally changing stripe 78 as a changer. The spirally changing stripe 78 serving as the changer may be deleted by using a deletion control 79, or the spirally changing stripe 78 serving as the changer may be edited by using an editing control 80.

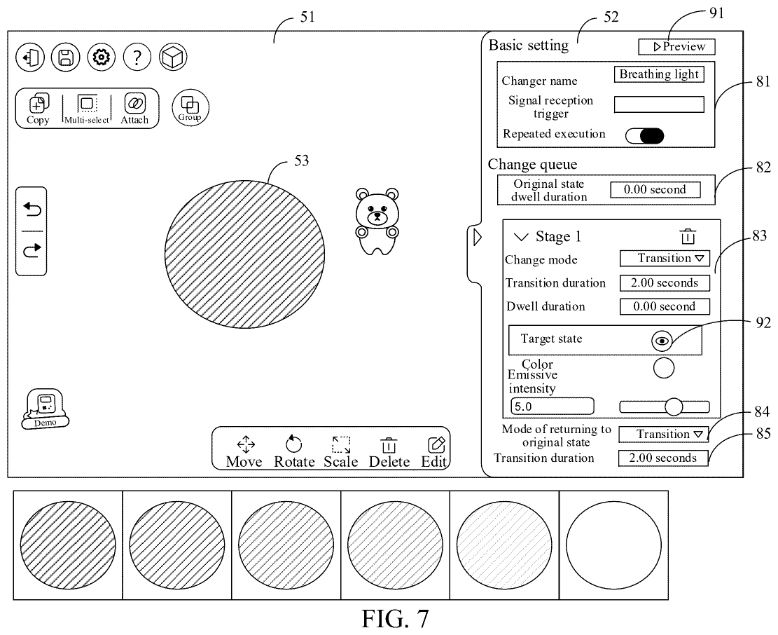

FIG. 7 is a schematic diagram of an interface for setting a breathing light of a changer. When a changer editing interface is entered, an editing control area 52 displays an editing control for the changer. For example, a basic setting 81 includes a changer name editing control, a signal reception trigger editing control, and a repeat execution editing control. The signal reception trigger editing control is a control for editing a trigger condition of the changer, which may be a character input control or a drop-down list control and is configured to instruct the changer to start to execute a skin change process according to a trigger signal received by a terminal. Original state dwell duration 82 (that is, dwell duration of an initial state of the virtual item 53 after the changer starts to be executed) and a stage 1 change editing control 83 are displayed in a change queue. The stage 1 change editing control 83 includes a control for editing a change mode from the initial state to a target state of stage 1, a control for editing transition duration in a transition switching mode, a control for editing dwell duration of the target state of stage 1, and a skin parameter editing control for the target state of stage 1 (in the figure, using the skin type being the emissive skin as an example, the skin parameter editing control includes a color editing control and an emissive intensity editing control). A control 84 for editing a mode of returning to an original state after the changer is executed and a control 85 for editing the transition duration in the transition switching mode are displayed at a lowest part of the editing control area 52.

The target state set in stage 1 may be previewed by triggering a target state preview control 92. That is, in a case that the target state preview control 92 is triggered, in response to editing of the skin parameter in stage 1, an editing preview area 51 updates a skin of the virtual item in real time, and a user may adjust a parameter through an instant visible effect change. An overall skin change process in an execution process of the changer may be previewed by triggering a changer preview control 91. That is, after the changer preview control 91 is triggered, the editing preview area 51 displays an overall process in which the virtual item executes the changer. Based on parameter settings in FIG. 7, after starting to execute the breathing light changer, a virtual item 53 changes to the target state of stage 1 in a mode of transition switching within 2 seconds. After execution of the changer ends, the virtual item 53 is changed to the initial state in a mode of transition switching within two seconds. A lower part of FIG. 7 shows a change process in which the virtual item 53 executes the changer, where darkness of a shadow indicates intensity of a skin color of the virtual item.

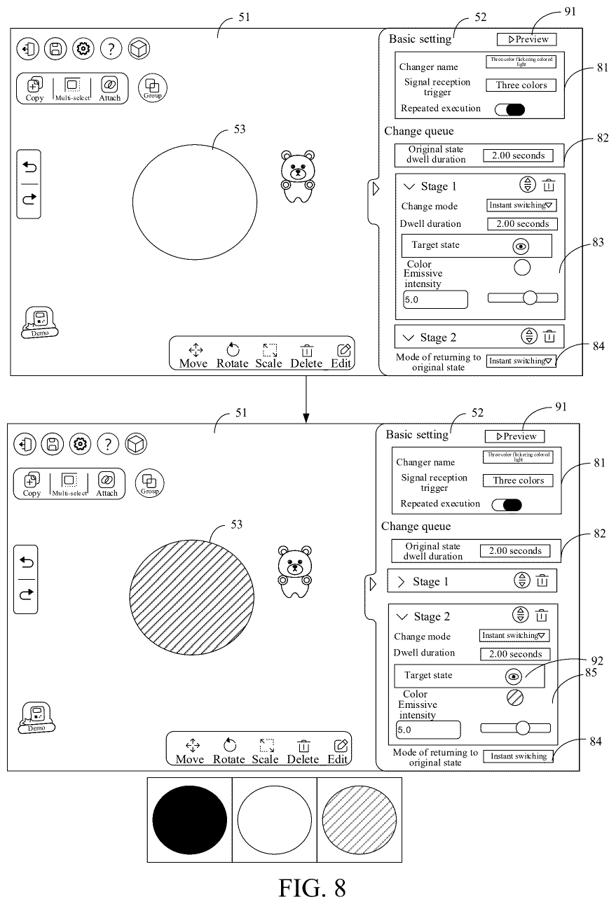

FIG. 8 is a schematic diagram of an interface for setting three-color flickering colored light of a changer. Different from FIG. 7, there are two stages in the change queue of the changer, that is, when executing the changer, the virtual item needs to experience changes in two stages. As shown in the figure, dwell duration of an original state (color 0) is set to 2 seconds; a skin color in the target state of stage 1 is set to color 1 by using a stage 1 change editing control 83, a change mode is instant switching, and dwell duration is 2 seconds; a skin color in the target state of stage 2 is set to color 2 by using a stage 2 change editing control 85, a change mode is instant switching, and dwell duration is 2 seconds; and a mode of returning to an original state in an instant switching mode is set by using a control 84 for editing a mode of returning to the original state.

The target state set in stage 2 may be previewed by triggering a target state preview control 92. That is, in a case that the target state preview control 92 is triggered, in response to editing of the skin parameter in stage 2, the editing preview area 51 updates a skin of the virtual item in real time, and a user may adjust a parameter through an instant visible effect change. An overall skin change process in an execution process of the changer may be previewed by triggering a changer preview control 91. That is, after the changer preview control 91 is triggered, the editing preview area 51 displays an overall process in which the virtual item executes the changer. Based on parameter settings in FIG. 8, after starting to execute the three-color flickering colored light changer, a virtual item 53 retains an original state (color 0) for 2 seconds, then is instantly switched to a target state color 1 in stage 1, stays for 2 seconds, and then is instantly switched to a target state color 2 in stage 2 and stays for 2 seconds. After execution of the changer ends, the virtual item 53 is changed to an original state (color 0) within 2 seconds in a mode of transition switching. A lower part of FIG. 8 shows a change process in which the virtual item 53 executes the changer, where black filling represents color 0, white filling represents color 1, and oblique line filling represents color 2.

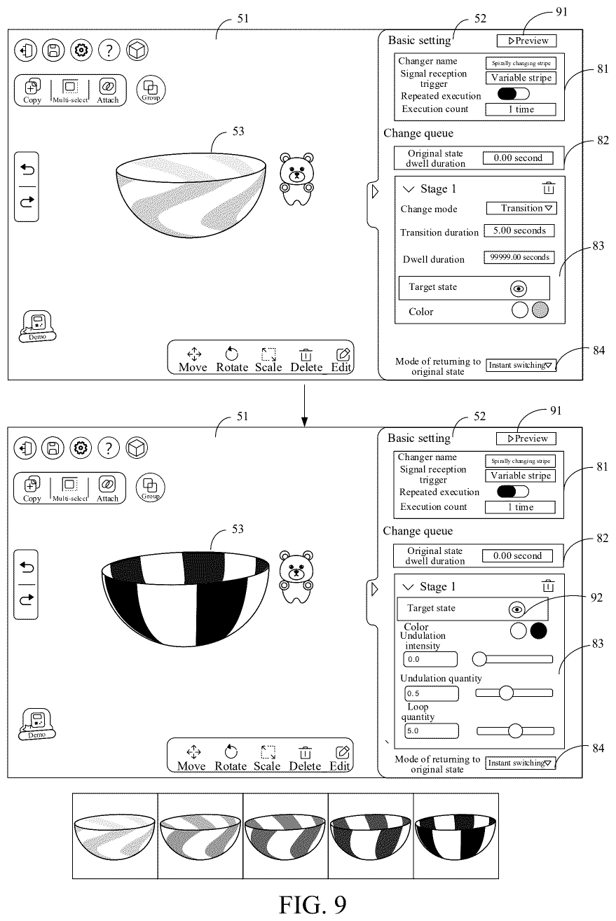

FIG. 9 is a schematic diagram of an interface for setting a spirally changing stripe of a changer. The changer only has a change in one stage, and an editing parameter in the stage 1 is set by using a stage 1 change editing control 83. In a case that a preview mode of stage 1 is enabled, that is, in a case that a target state preview control 92 is triggered, and when a parameter related to a skin parameter in a stage 1 change editing control 83 is edited, an editing preview area 51 instantly displays a skin effect of an edited virtual item. For example, after a color parameter and an undulation quantity of the skin (as displayed in an interface of an upper half part in FIG. 9) of the virtual item in an initial state are edited, and the editing preview area 51 updates and displays the edited skin (as displayed in an interface of a lower half part in FIG. 9) of the virtual item in real time. After a changer preview control 91 is triggered, the editing preview area 51 displays an overall process in which the virtual item executes the changer. A lower part of FIG. 9 shows a change process in which a virtual item 53 executes the changer. It can be learned that in the process of executing a spirally changing stripe of the changer, both a texture and color of the skin of the virtual item 53 are changed in a mode of transition switching.

It can be learned from FIG. 6 to FIG. 9 that in this technical solution, a plurality of dynamic change presentations may be added to a skin presentation of the virtual item by using the changer. One or more changers may be provided, and a sequence of priorities may be adjusted to the changers sequentially in a case that there is a plurality of changers. In a single changer, a plurality of change stages may be set, whereby the skin of the virtual item can be changed continuously in a plurality of stages, and presentations are enriched. In addition, when the target state of the skin of the virtual item that is subjected to the changer is edited, the skin of the virtual item can be updated in real time in the editing preview area according to an edited parameter, whereby the user can immediately observe an edited effect, a plurality of repeated operations caused by repeated adjustment to adjust to a satisfying skin effect and a plurality of signaling interactions with a terminal device can be avoided, the user can adjust to the satisfying effect more quickly, and editing efficiency and human-computer interaction efficiency of the user are improved.

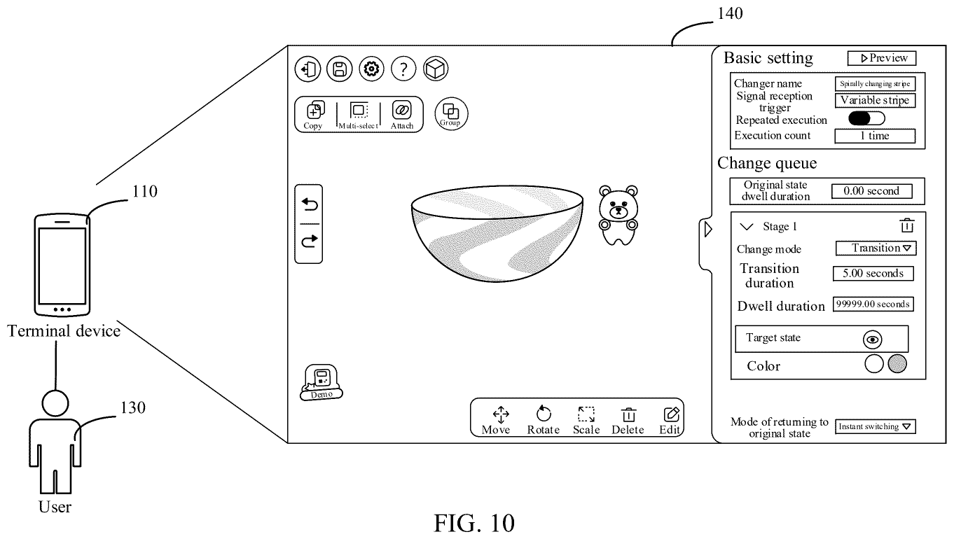

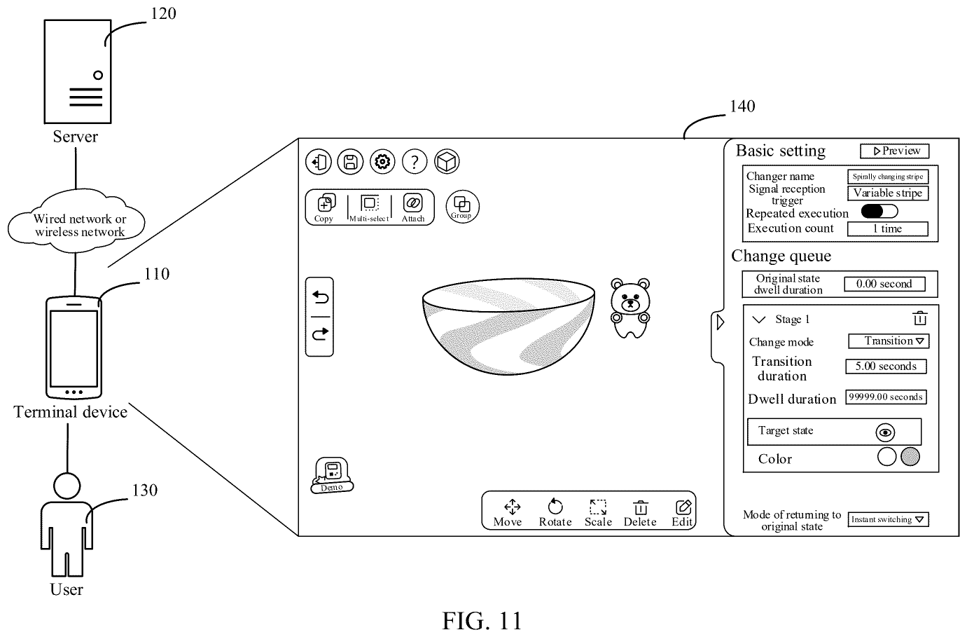

FIG. 10 and FIG. 11 are schematic diagrams of a computer system according to an embodiment of this disclosure. The computer system may include a terminal device 110.

The terminal device 110 may be a laptop portable computer, a desktop computer, a mobile phone, a tablet computer, an ebook reader, an electronic game console, or the like.

The terminal device 110 includes a memory and a processor. The memory may include one or more computer-readable storage media. The foregoing computer-readable storage medium includes at least one of a random access memory (RAM), a read only memory (ROM), and a flash. An operating system and a game program are installed in the memory.

The game program may be any one of a level-clearing game, a casual competitive game, a massive multiplayer online game (MMOG), a chess and card game, a multiplayer online battle arena (MOBA) game, a simulation game (SLG) game, a virtual reality application program, a three-dimensional map program, a first-person shooting game (FPS), and a multiplayer gunfight survival game.

The operating system is basic software that provides secure access to computer hardware for the game program. The operating system may be an Android system or an iPhone operating system (IOS). The operating system supports downloading, installation, and running of the game program.

In some embodiments, the terminal device 110 further includes a touchscreen. The touchscreen may be a capacitive screen or a resistive screen. The touchscreen is configured to implement interaction between the terminal device and a user 130. In this embodiment of this disclosure, the terminal device obtains, by using a touchscreen, an interaction operation triggered by the user 130 on an editor interface 140 of a UGC editor in the game program.

The game program is installed and run on the terminal device 110, and the game program is designed with a UGC editor interface 140.

The UGC editor interface 140 supports operations such as editing, saving, and releasing performed by the user 130 on a virtual environment. When editing the virtual environment, the user 130 may set up different virtual environments by using a virtual object. The UGC editor supports the user 130 to create a moving object to enrich the virtual environment, to improve operability and interest of the user.

The terminal device 110 is a terminal device used by the user. The user 130 operates the editor interface 140 by using the terminal device 110, and the user 130 may save the virtual environment that is being edited or that has been edited to the terminal device 110. In some embodiments, the terminal device 110 is configured to upload virtual environment information saved by the user 130 to a server 120. In some aspects, the terminal device 110 is configured to provide data information of a virtual environment and a virtual object for a game program. In some aspects, the terminal device 110 is configured to save a skin parameter of a virtual item.

In some embodiments, the computer system further includes a server 120, as shown in FIG. 11. The server 120 may be any one of a plurality of servers, virtual cloud storages, or cloud computing centers. In some embodiments, the server 120 is configured to save virtual environment information uploaded by the terminal device 110. In some aspects, the server 120 is configured to save a skin parameter of a virtual item uploaded by the terminal device 110. In some aspects, the server 120 is configured to provide data information of a virtual environment and a virtual object for a game program.

In some embodiments, the terminal device 110 is connected to the server 120 by using a wired or wireless network.

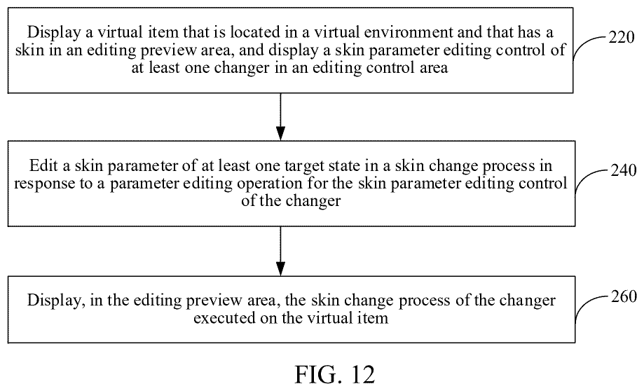

FIG. 12 is a schematic diagram of an information processing method according to an embodiment of this disclosure. The method is performed by a terminal device, and the terminal device may be the terminal device shown in FIG. 10 and FIG. 11. The method includes the following operations.

Operation 220: Display a virtual item that is located in a virtual environment and that has a skin in an editing preview area, and display a skin parameter editing control of at least one changer in an editing control area. In one example, a virtual object in a virtual environment is displayed, by processing circuitry, in an editing preview area of a UGC editing interface of a game program based on execution of the game program. In one example, at least one changer, configured to define a skin change process of the skin of the virtual object in a game process, is displayed by the processing circuitry in an editing control area of the of the UGC editing interface.

In some aspects, a skin of the virtual item may correspond to a collection of surface visible attributes of the virtual item. In some aspects, the surface visual attributes include at least one of color, texture, smoothness, transparency, reflectivity, refractive index, and emissive intensity of a surface of the virtual item.

A skin parameter of the skin may correspond to one or more attributes including at least one of the following:
a skin type, configured for indicating a type of the skin of the virtual item;
a skin color, configured for indicating a color of the skin of the virtual item;
an emissive intensity, configured for indicating emissive intensity of the skin in a case that the skin type of the virtual item is an emissive skin, where, for example, a virtual item 53 in FIG. 4(b) has an emissive skin, and an effect of the emissive skin is adjusted according to the emissive intensity;
a skin texture, configured for indicating a texture of the skin in a case that the skin type of the virtual item is a textured skin, where, for example, a virtual item 53 in FIG. 5 has a textured skin, and a skin texture of the skin is a spiral texture; and
a gradient mode, configured for indicating a gradient effect of the skin in a case that the skin type of the virtual item is a gradient skin. For example, the virtual item 53 in FIG. 4(c) has a gradient skin, and the gradient mode corresponding to the gradient skin is jointly determined based on a gradient axial direction, a gradient center, and a gradient intensity.

The changer is a functional module that is provided in a game program and that is configured to edit a skin change process of the virtual item in a game process. A plurality of changers may be set for one virtual item. A plurality of change stages may be set for a single changer. For example, a breathing light changer shown in FIG. 7; for another example, a three-color flickering color light changer shown in FIG. 8 has two change stages; and for another example, a spirally changing stripe changer shown in FIG. 9 has only one change stage.

In some embodiments, the changer starts to be executed according to a trigger signal received by a terminal. In some aspects, the trigger signal is not set for the changer, and in a case that there are a plurality of changers, the changers are executed sequentially according to a priority sequence.

In some aspects, the editing preview area and the editing control area are displayed in an editor interface of a UGC editor. The virtual item that is located in the virtual environment and that has the skin is displayed in the editing preview area; and the skin parameter editing control of the at least one changer is displayed in the editing control area.

A picture of the virtual environment is a picture obtained by collecting a three-dimensional virtual environment by using a camera model. A user may control the camera model by using an interaction operation on the terminal to change a display effect of the picture of the virtual environment.

In some embodiments, the virtual item is provided by a UGC editor. In some aspects, the virtual item is obtained by a user by combining virtual items provided by a UGC editor. In some aspects, the virtual item is generated by a UGC editor after a user imports a picture into the UGC editor. In some aspects, the virtual item is a virtual item created by a user of the UGC editor and saved in a public library.

In some embodiments, an editing control configured for deleting, editing, or adding a changer is displayed in the editing control area.

In some embodiments, at least two changers are provided, and a priority adjustment control configured for adjusting priorities of the changers is further displayed in the editing control area.

In some embodiments, the editing control area further includes at least one of a first changer setting control, a second changer setting control, and a third changer setting control. The first changer setting control is configured for editing a name of the changer, the second changer setting control is configured for editing a trigger condition of the changer, and the third changer setting control is configured for editing a repetition count of the changer.

In some embodiments, the editing control area further includes at least one of a first switching setting control and a second switching setting control. The first switching setting control is configured for editing a switching mode for switching different skins of the virtual item. The switching mode includes at least one of instant switching and transition switching. The second switching setting control is configured for editing transition duration that the virtual item performs skin switching in the transition switching mode.

In some embodiments, the editing control area further includes at least one of a first dwell time setting control and a second dwell time setting control. The first dwell time setting control is configured for editing a dwell time of an initial skin of the virtual item, and the second dwell time setting control is configured for editing a dwell time of a skin in at least one target state.

In some embodiments, the editing control area includes a trigger signal editing control of the at least one changer, and a trigger signal of the at least one changer may be set in response to an editing operation for the trigger signal editing control.

Operation 240: Edit a skin parameter of at least one target state in a skin change process in response to a parameter editing operation for the skin parameter editing control of the changer. In one example, a skin parameter corresponding to one of the surface visible attributes of at least one target state in the skin change process is set based on a parameter editing operation of a skin parameter editing control element of the changer.

In some aspects, the user performs the parameter editing operation by using the skin parameter editing control of the changer, and the terminal edits the skin parameter of the at least one target state in the skin change process in response to the parameter editing operation. The parameter editing operation of the user may be at least one of a click operation, a double-click operation, an input operation, a pulling operation, a touch operation, a pressing operation, a voice input operation, a gesture control operation, and an eye control operation.

In some embodiments, for a value type parameter, at least one of controls for an input operation and a pulling operation is set. For example, for the control for the input operation, in response to triggering of the user to the control, a numeric keyboard pops up and is displayed for the user to input. For another example, for the control for the pulling operation, in response to the pulling operation of the user on a slider on a pull bar, a value changes. For an option type parameter, the user edits the parameter by selecting a target parameter from a plurality of parameters displayed on an interface, or by viewing a drop-down list and then selecting a target parameter from the drop-down list.

Because the skin has a plurality of types of skin parameters, a skin parameter editing control is set for each type of skin parameter, and different types of skin parameters are edited by using editing operations for the skin parameter editing controls. Editing for different types of skin parameters is shown below.

### The Skin Parameter is a Skin Type

The skin parameter editing control includes a skin type selection control. The skin type of at least one target state in the skin change process is selected in response to a first selection operation for the skin type selection control of the changer. The first selection operation may be at least one of a click operation, a double-click operation, a touch operation, a pressing operation, a voice input operation, a gesture control operation, and an eye control operation.

In some embodiments, a virtual item having the skin type of a first target state is displayed in the editing preview area in response to a selection for the skin type of the first target state. The first target state is any one of the at least one target state in the skin change process.

### The Skin Parameter is a Skin Color

The skin parameter editing control includes a skin color editing control. A skin color of at least one target state in the skin change process is selected in response to a second selection operation for the skin color editing control of the changer. The second selection operation may be at least one of a click operation, a double-click operation, a touch operation, a pressing operation, a voice input operation, a gesture control operation, and an eye control operation.

A virtual item having the skin color of a first target state is displayed in the editing preview area in response to a selection for the skin color of the first target state. The first target state is any one of the at least one target state in the skin change process.

### The Skin Parameter is Emissive Intensity

The skin parameter editing control includes an emissive intensity editing control. An emissive intensity of at least one target state in the skin change process is edited in response to a first editing operation for the emissive intensity editing control of the changer. The first editing operation includes at least one of an input operation, a selecting and pulling operation, a pressing and dragging operation, a voice input operation, a gesture control operation, and an eye control operation.

A virtual item having an emissive intensity of a first target state is displayed in the editing preview area in response to editing for the emissive intensity of the first target state. The first target state is any one of the at least one target state in the skin change process.

### The Skin Parameter is Skin Texture.

The skin parameter editing control includes a skin texture editing control. A skin texture of at least one target state in the skin change process is edited in response to a second editing operation for the skin texture editing control of the changer, the second editing operation being configured for editing at least one of the following parameters: a texture undulation intensity, a texture undulation quantity, and a texture repetition quantity. The second editing operation includes at least one of an input operation, a selecting and pulling operation, a pressing and dragging operation, a voice input operation, a gesture control operation, and an eye control operation.

A virtual item having a skin texture of a first target state is displayed in the editing preview area in response to editing for the skin texture of the first target state. The first target state is any one of the at least one target state in the skin change process.

### The Skin Parameter is a Gradient Mode

The skin parameter editing control includes a gradient mode editing control. A gradient mode of at least one target state in the skin change process is edited in response to a third editing operation for the gradient mode editing control of the changer, the third editing operation being configured for editing at least one of the following parameters: a gradient axial direction, a gradient center, and a gradient intensity. The third editing operation includes at least one of an input operation, a selecting and pulling operation, a pressing and dragging operation, a voice input operation, a gesture control operation, and an eye control operation.

The foregoing is merely an example of the skin parameter shown in this embodiment of this disclosure, and the skin parameter involved in this disclosure is not limited thereto. In technical solutions of this disclosure, a parameter type and a color quantity that are opened to the user may be freely added or modified.

For example, the skin parameter may further include a cloth presentation parameter of a fur skin. For another example, an anthropometric parameter affects presentations of skin highlight in different directions, that is, there are different gloss presentations according to different observation angles. The anthropometric parameter can control degrees of these gloss presentations. The skin is more similar to cotton when the anthropometric parameter is 0, and the skin is more similar to silk when the anthropometric parameter is 1. Therefore, more adjustment space can be provided for a player by providing a single skin. For another example, a velvet rim parameter is configured for controlling brightness contrast between a control center and an edge, and can simulate a presentation that a fur material is darker in the middle and brighter at a rim and has a gentle transition in reality. For another example, for a waveform pattern generated by using trigonometric function superposition, a block-like or dotted waveform is obtained by using some change actions, and the effect may be controlled by using an amplitude, a frequency, and a flow rate of a wave. For another example, the skin parameter further includes a medium density parameter, that is, for a water skin, by using the medium density parameter, effects of deep water and shallow water are increased, and a transition presentation of the deep water and the shallow water is controlled.

A parameter editing operation for the skin parameter editing control of the changer in this operation is a parameter editing operation for at least one skin parameter. That is, one skin parameter may be edited, or a plurality of skin parameters may be edited. This is not limited in this disclosure.

A virtual item having a gradient mode of a first target state is displayed in the editing preview area in response to editing of the gradient mode of the first target state. The first target state is any one of the at least one target state in the skin change process.

In some embodiments, the editing control area further includes a target state preview control (for example, a target state preview control 92 in FIG. 7 to FIG. 9). The target state preview control is configured for previewing a skin of an edited target state when any target state of the changer is edited, whereby a user can instantly obtain a skin effect after the parameter is changed, and can quickly determine a skin parameter of the target state. In a case that a preview of the first target state is enabled (for example, the preview is enabled by clicking a target state preview control), the virtual item having the skin parameter of the first target state is displayed in the editing preview area in response to the editing operation for the skin parameter of the first target state. In some examples, the virtual object having the skin parameter of a first target state of the at least one target state may be displayed in the editing preview area based on the parameter editing operation corresponding to the setting of the skin parameter of the first target state, when a preview of the first target state is enabled.

Operation 260: Display, in the editing preview area, the skin change process of the changer executed on the virtual item. In one example, the virtual object is displayed in the editing preview area based on execution of the skin change process defined by the changer.

In some aspects, the skin change process in which the changer is executed on the virtual item is displayed in the editing preview area. For example, after completing setting the at least one changer, the user clicks a changer preview control (for example, a changer preview control 91 in FIG. 6 to FIG. 9), to display the skin change process in which the changer is executed on the virtual item in the editing preview area. That is, the skin change process in which the changer is executed on the virtual item is displayed in the editing preview area in response to a trigger operation for the changer preview control. In one example, the virtual object is displayed in the editing preview area based on the execution of the skin change process and based on a trigger operation on a changer preview control element.

In some embodiments, in a case that the changer is set with a trigger signal, when the changer preview control is triggered, the trigger signal is received by default, and for the virtual item, the overall skin change process corresponding to the changer is executed according to settings of the changer.

In some embodiments, when the changer is set to be repeatedly executed, after a user manually turns off a changer preview (for example, clicks the changer preview control again), the virtual item restores to an initial state. In a case that the changer is not repeatedly executed but is set with an execution count, the user does not need to manually turn off the changer, the changer preview control is automatically switched back to an off state after a corresponding count of executions are performed on the changer, and the user may click again the changer preview control to preview.

In conclusion, according to the method provided in this embodiment, a user adds a plurality of types of dynamic change presentations to a skin presentation of a virtual item by editing a changer. A plurality of types of skin parameters may be edited in the changer, and more parameter interfaces are opened for the user, whereby the user has more choices and can better participate in creation of UGC. Presentation of the UGC is enriched, skin resources provided by a game program are more fully used, and resource utilization is improved.

In addition, one or more changers may be provided, whereby the virtual item may obtain a plurality of different change presentation capabilities, skin resources are more fully used, and resource utilization is improved.

In addition, in a single changer, a plurality of change stages may be set, whereby the skin of the virtual item can be changed continuously in a plurality of stages, presentation is enriched, skin resources are more fully used, and resource utilization is improved.

In addition, when the target state of the skin of the virtual item that is subjected to the changer is edited, the skin of the virtual item can be updated in real time in the editing preview area according to an edited parameter, whereby the user can immediately observe an edited effect, a plurality of repeated operations caused by repeated adjustment to adjust to a satisfying skin effect and a plurality of signaling interactions with a terminal device can be avoided, the user can adjust to the satisfying effect more quickly, and editing efficiency and human-computer interaction efficiency of the user are improved.

In some aspects, the user may preview an overall change effect of the changer, which further improves editing efficiency of the user is further improved, and improves human-computer interaction efficiency.

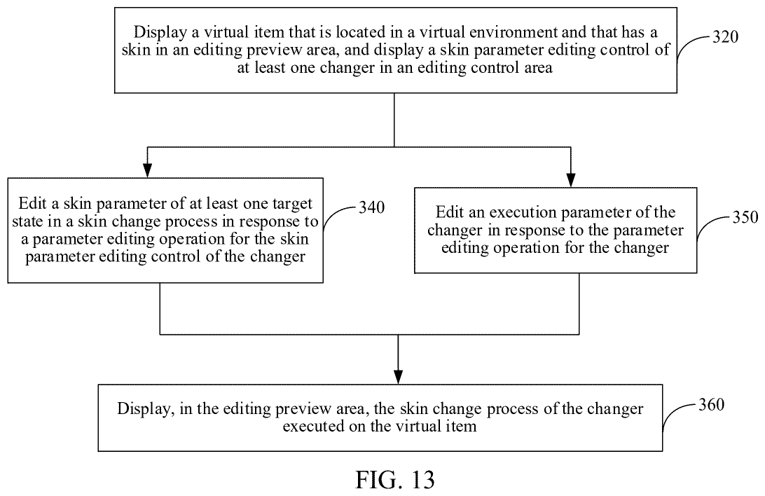

FIG. 13 is a schematic diagram of an information processing method according to an embodiment of this disclosure. The method is performed by a terminal device, and the terminal device may be the terminal device shown in FIG. 10 and FIG. 11. Based on the embodiment of FIG. 12, a method for generating UGC shown in FIG. 13 further includes editing an execution parameter of the changer. The method includes the following operations.

Operation 320: Display a virtual item that is located in a virtual environment and that has a skin in an editing preview area, and display a skin parameter editing control of at least one changer in an editing control area.

In some aspects, the editing preview area and the editing control area are displayed in an editor interface of a UGC editor. The virtual item that is located in the virtual environment and that has the skin is displayed in the editing preview area; and the skin parameter editing control of the at least one changer is displayed in the editing control area.

For an example of a specific description, reference can be made to operation 220, and details are not described herein again.

The following operation 340 and operation 350 are not performed in any particular sequence. Operation 340 may be first performed and then operation 350 is performed, operation 350 may be first performed and then operation 340 is performed, or operation 340 and operation 350 may be simultaneously performed.

Operation 340: Edit a skin parameter of at least one target state in a skin change process in response to a parameter editing operation for the skin parameter editing control of the changer.

In some aspects, the user performs the parameter editing operation on the skin parameter editing control of the changer, and the terminal edits the skin parameter of the at least one target state in the skin change process in response to the parameter editing operation.

For an example of a specific description, reference can be made to operation 340, and details are not described herein again.

Operation 350: Edit an execution parameter of the changer in response to the parameter editing operation for the changer.

The execution parameter of the changer includes parameters such as a basic setting of the changer, a dwell time of each state, and a switching mode between states. Descriptions are provided below:

### Setting of Dwell Time

The editing control area further includes at least one of a first dwell time setting control and a second dwell time setting control.

In some embodiments, a dwell time of an initial skin of the virtual item is edited in response to an editing operation for the first dwell time setting control. The dwell time of the initial skin is a fixed starting item of the editing control area, and specifies how long the initial state is retained after the game starts/a signal is received before entering a change stage queue. The first dwell time setting control is at least one of a value input control and a slide control.

In some embodiments, a dwell time of the skin of the at least one target state is edited in response to an editing operation for the second dwell time setting control. The dwell time indicates dwell duration of state B after state A is changed to state B (that is, waiting duration to a next stage). The second dwell time setting control is at least one of a value input control and a slide control.

### Basic Setting of Changer

The editing control area further includes at least one of a first changer setting control, a second changer setting control, and a third changer setting control.

In some embodiments, a name of the changer is edited in response to an editing operation for the first changer setting control. The first changer setting control is a character input control.

In some embodiments, a trigger condition of the changer is edited in response to an editing operation for the second changer setting control. The second changer setting control is a character input control or a drop-down list control. That is, a player predefines a signal, and a trigger signal is edited in a mode of character input or drop-down list selection. When a user triggers the signal by using a virtual item or an operation in a game process, a corresponding changer will be executed.

In some embodiments, a repetition count of the changer is edited in response to an editing operation for the third changer setting control. When a switch of a repetition count editing control is disabled, that is, the changer cannot be executed repeatedly all the time, an input row of “execution count” is displayed, which defaults to 1 time, and can be changed into any natural number greater than 0 by a user. After the changer is triggered, the changer is executed for changer cycles with a quantity that is the same as an input count, and returns to an original state after being executed. When the switch is enabled, an execution count does not need to be input, and an effect of executing a corresponding changer is repeated without interruption from other high priority changers. For a changer that does not need to be triggered by a signal, after being interrupted, the changer is resumed to be repeatedly executed again after a high priority changer is executed. For a changer that needs to receive a signal for triggering, after being interrupted, the changer can only be resumed to be repeatedly executed again by receiving a corresponding signal again after a high priority changer is executed. The third changer setting control is at least one of a switch control, a slide control, and a value input control.

### Setting of State Switching

The editing control area further includes at least one of a first switching setting control and a second switching setting control.

In some embodiments, a switching mode of switching different skins of the virtual item is edited in response to an editing operation for the first switching setting control, where the switching mode includes at least one of instant switching and transition switching. A switching mode is selected by using a drop-down box. When the transition switching mode is selected, a row of “transition duration” input boxes is correspondingly added, to indicate time spent in changing from state A to state B (duration in which an AB mixed state exists). When the instant switching mode is selected, state A is switched to state B instantly without an AB mixed state, duration does not need to be input, and a “transition duration” input box is not displayed. The first switching setting control is at least one of a drop-down list control, a slide control, and a switch control,

In some embodiments, transition duration that the virtual item performs skin switching in the transition switching mode is edited in response to an editing operation for the second switching setting control. The second switching setting control is at least one of a value input control and a slide control. For example, in a case that the transition switching is selected as a mode of returning to an original state, switching duration of the transition switching is edited to 2 seconds.

### Adjustment of Priority of Changer

In a case that more than one changer is provided, an adjustment control for a priority of a changer is further displayed in the editing control area. Priorities of at least two changers are adjusted in response to a priority adjustment operation for each changer. The priorities of the at least two changers are configured for indicating an execution sequence of executing the at least two changers in the game process. For example, for a priority adjustment control 76 in FIG. 6, the execution sequence of a plurality of changers is adjusted by using a trigger operation for the control, for example, the priorities of the changers are adjusted by dragging the changers after the control is clicked. In one example, priorities of two or more changers may be adjusted based on a priority adjustment operation of each changer of the two or more changers. In one example, the priorities of the two or more changers indicate a sequence of an execution of each of the two or more changers in the game process.

### Editing of Trigger Signal

The editing control area further includes a trigger signal editing control of at least one changer. A trigger signal of the at least one changer is set in response to an editing operation for the trigger signal editing control. The trigger signal is configured for instructing to trigger, in a game process, the virtual item to execute the at least one changer. For example, a trigger signal of three-color flickering colored light of a changer is set to “three colors”, and after receiving the “three colors” signal, the terminal starts to execute the changer. In one example, a trigger signal of the changer is set based on an editing operation of the trigger signal editing control. In one example, the trigger signal instructs a triggering of the execution of the skin change process defined by the changer in a game process.

In some embodiments, a control for editing a mode of returning to an original state is a fixed ending item, and specifies that a mode of returning to an original state after all change stages of a changer are executed is equivalent to a setting of a change mode in the stages.

Operation 360: Display, in the editing preview area, the skin change process of the changer executed on the virtual item.

In some aspects, the skin change process in which the changer executed on the virtual item is displayed in the editing preview area. For example, after setting at least one changer, a user clicks a demo control, to display, in the editing preview area, the skin change process of the changer executed on the virtual item.

In some embodiments, in a case that input content of a trigger signal editing control of the changer is not null, a skin change process in which the first changer is executed on the virtual item is displayed in a virtual environment in response to receiving a first trigger signal. The first trigger signal is configured for instructing to trigger, in a game process, executing the first changer on the virtual item. In one example, when input content of a trigger signal editing control of the changer is not null, the virtual object is displayed based on the execution of the skin change process defined by the changer when a trigger signal is received. In one example, the trigger signal indicates a triggering of the execution of the skin change process defined by the changer.

That is, in a case that the input content of the trigger signal editing control is null, the skin change process corresponding to the changer is immediately executed on the virtual item after a game is started. In a case that the input content of the trigger signal editing control of a plurality of changers is null, skin change processes of the plurality of changers are executed according to a priority sequence. In a case that the input content of the trigger signal editing control is not null, that is, a trigger signal of a changer is preset, after receiving the trigger signal, the terminal executes the changer corresponding to the trigger signal.

In addition, a priority of a changer set with a trigger signal is higher than that of a changer not set with a trigger signal, that is, after receiving the trigger signal, the terminal immediately interrupts the changer that is executed currently and executes the changer corresponding to the trigger signal.

In some embodiments, a priority of a third trigger signal that is received later is higher than a priority of a second trigger signal that is received earlier. The second trigger signal and the third trigger signal are two different trigger signals.

That is, in a case that a trigger signal received later is different from a trigger signal received earlier, even if a changer corresponding to the trigger signal received earlier is not completely executed, the changer is immediately interrupted, and a changer corresponding to the trigger signal received later is executed instead.

That is, in response to receiving the second trigger signal, a skin change process of a second changer executed on the virtual item is displayed in the virtual environment, and the second changer is a changer corresponding to the second trigger signal. In response to receiving the third trigger signal, and in a case that the skin change process of the second changer is not ended, the skin change process of the second changer is interrupted, and a skin change process of a third changer executed on the virtual item is displayed in the virtual environment, and the third changer is a changer corresponding to the third trigger signal. The second trigger signal and the third trigger signal are two different trigger signals.

However, in a case that successively received trigger signals are consistent, if a changer corresponding to a preceding trigger signal has not been completely executed, the changer continues to be executed, and is not re-executed. If the preceding trigger signal has been completely executed, the changer corresponding to the trigger signal is re-executed.

That is, in response to receiving a fourth trigger signal, a skin change process of a fourth changer executed on the virtual item is displayed in the virtual environment, and the fourth changer is a changer corresponding to the fourth trigger signal. In response to receiving the fourth trigger signal again, in a case that the skin change process of the fourth changer triggered by the preceding received fourth trigger signal has been ended, the skin change process of the fourth changer is displayed in the virtual environment again; and in a case that the skin change process of the fourth changer triggered by the preceding received fourth trigger signal has not been ended, the skin change process of the fourth changer triggered by the preceding received fourth trigger signal continues to be displayed.

In conclusion, according to the method provided in this embodiment, a user adds a plurality of types of dynamic change presentations to a skin presentation of a virtual item by editing a changer. A plurality of types of skin parameters may be edited in the changer, and more parameter interfaces are opened for the user, whereby the user has more choices and can better participate in creation of UGC. Presentation of the UGC is enriched, skin resources are more fully used, and resource utilization is improved.

In some aspects, one or more changers may be provided, and a priority sequence may be adjusted to sequentially execute the changers in a case that there are a plurality of changers, whereby the virtual item may obtain a plurality of different change presentation capabilities, skin resources are more fully used, and resource utilization is improved.

In addition, in a single changer, a plurality of change stages may be set, whereby the skin of the virtual item can be changed continuously in a plurality of stages, presentation is enriched, skin resources are more fully used, and resource utilization is improved.

In addition, different states of the changer may be switched in an instant switching mode, or may be switched in a transition switching mode. Different switching methods are increased, more change modes (for example, a breathing light) are implemented, skin resources are more fully used, and resource utilization is improved.

In addition, when the target state of the skin of the virtual item that is subjected to the changer is edited, the skin of the virtual item can be updated in real time in the editing preview area according to an edited parameter, whereby the user can immediately observe an edited effect, a plurality of repeated operations caused by repeated adjustment to adjust to a satisfying skin effect and a plurality of signaling interactions with a terminal device can be avoided, the user can adjust to the satisfying effect more quickly, and editing efficiency and human-computer interaction efficiency of the user are improved.

When the user sets a movement mode of the virtual object to a key movement point movement mode, a first key movement point, that is, a starting point, is automatically generated according to a current state of the virtual object, and the user does not need to search for a control to create, whereby editing efficiency of the user and friendliness of a game program are improved.

In the related technology, batching of virtual items is greatly limited. In a related technology, colors and parameters (for example, a parameter corresponding to a skin type) of skin of virtual items are stored in skin instances of the virtual items, and each instance manages its own data independently. Therefore, batching can be used only when the colors and the parameters are the same. For example, 10 identical spheres are all white in color, but are different in size and placed at different positions. The 10 spheres may be drawn in the same batch. However, if one of the spheres becomes off-white, the off-white sphere needs to be separately submitted for drawing. However, in UGC, color change is a very common user operation. If a user massively uses color change, a draw call in a game scene is so high that a mobile device cannot bear. Therefore, batching in the related technology has difficulty and defects.

In this technical solution, a data structure of an unreal engine 4 (UE4) when a GPU scene is implemented is used, and new planning is performed on the data structure, to optimize batching during generation of the UGC.

First, this data structure is described. UE4 defines a data structure FPrimitiveSceneData in SceneData.ush, which includes various parameters and matrix data required by a shader, and further defines an array of a float4 type array, that is, custom primitive data after fixedly used data, which is configured for storing some custom primitive data. Because the UE4 engine stores FPrimitiveSceneData of all virtual items in an entire scene together, batching is not interrupted when a skin of a virtual item samples the data.

When the skin of the virtual item is processed, a value source of a skin parameter may be controlled by checking a “use custom primitive data” option of the skin parameter and setting an index value. For example, when this option is not checked for a skin parameter, a value set on a skin instance is directly obtained during rendering. After the option is checked, data is read from a value with an index in values of the custom primitive data during rendering.

Currently, an array size of the custom primitive data is fixed to 6, and a maximum of 24 pieces of custom float data can be used for an array of a float4 type. For RGB colors, three float data bits are occupied, that is, one material supports a maximum of four custom colors. For a common parameter, only one float data bit is occupied. Therefore, each time an RGB color is reduced, three more data bits can be provided to a parameter that needs to be opened to a user.

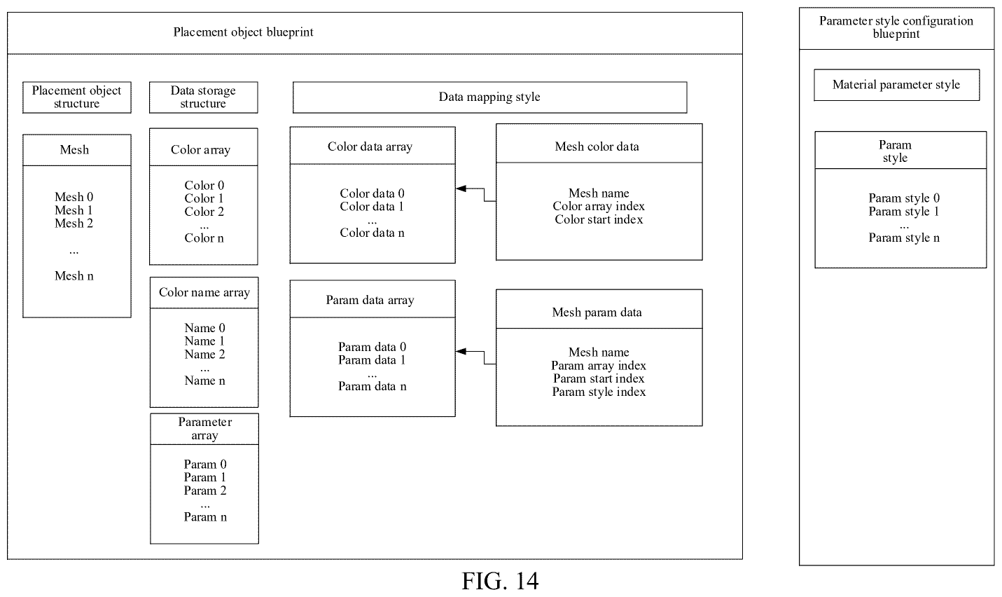

Then, based on this principle, a static editing solution that supports color and parameter adjustment and supports related data storage and reading during game production is designed to manage colors and some parameters of a UGC skin, to solve a batch capability of being compatible with a GPU scene while supporting color and parameter changes during running. FIG. 14 is a schematic diagram of a data structure and logical mapping according to an embodiment of this disclosure.

A blueprint of a placement object (that is, a virtual item) shown on a left side of FIG. 14 includes three parts: a placement object structure, a data storage structure, and a data mapping relationship. Detailed descriptions are provided below one by one:
(1) The placement object structure: one mesh root exists in the placement object of the UGC, and one or more models may be mounted below the mesh root. The models are named as node 0, node 1, node 2, and the like. These models are alone or combined into a virtual item that may be dragged and dropped by a user into a virtual scene. The models are in a mapping relationship with skins. Therefore, it is agreed that one model supports a maximum of four colors. When one element is combined by n models, the element supports a maximum of 12n pieces of float data (1 RGB color needs 3 float data bits), that is, 4n colors.
(2) Data storage structure: including a color array, a color name array, and a param array. The color array and the param array are user-adjustable, and therefore, the color array and the param array are saved in an attribute of an actor in a form of a field, serialized into a pbin file together with UGC map saving logic, and restored to each virtual item instance when a map is initialized.
(3) Data mapping relationship: for a color and a parameter, two corresponding data structures can be separately designed: mesh color data and mesh param data to respectively store a mapping relationship between a model and a color, and a mapping relationship between a model and a parameter in each placement object. Quantities of colors and parameters of the entire placement object correspond to quantities of the mesh color data and the mesh param data. These mapping relationships respectively form two arrays: a color data array and a param data array, and are stored in a component named color change component in the blueprint of the placement object. Because these relationships are rules that have already been determined when the blueprint is created, the relationships do not need to be stored and serialized into map data.

The mesh color data describes the mapping relationship between the model and the color, and parameters and functions of the mesh color data are respectively as follows:
mesh name: indicating a model name, and describing a model that is configured with a placement element (a virtual item) and where the mesh name is currently located;
color array index: describing that a color value with an Index is obtained from the color array; and
color start index: describing a start position of a color that needs to be set. Colors are stored by using RGB and occupy three float values; and therefore, a start value of an n^{th} color is 3n.

The mesh param data describes a mapping relationship between the model and the parameter, and members and functions in the mesh param data are respectively as follows:
mesh name: a model name for describing a model that is configured with a placement element and where the mesh name is currently located;
param array index: describing that a parameter value with an Index is obtained from the param array;
param start index: describing a position of a parameter that needs to be set; and
param style name: this name corresponds to a param style name in a param style configuration blueprint, and describes a form in which a parameter is to be displayed on an interactive panel.

A param style configuration blueprint shown on a right side of FIG. 14 includes a material parameter style. The function of the material parameter style is to define styles of all UGC open skin parameters in a BPAC_CustomMaterialParameter blueprint, a UGC universal interaction component is reused by using great commonality of the UGC open skin parameter, and resource waste caused by defining a set of parameters for each virtual item is avoided. That is, when displayed on the interactive panel, an interaction form in which the parameter is to be displayed is determined by using the param style name.

Based on the foregoing data structure, virtual items having the same skin type may be batched even if parameters corresponding to colors and skin types are different. That is, skins of virtual items in at least two different states are drawn in the same batch, and the skins of the virtual items in the at least two different states have the same skin type.

Next, parameter planning of different skin types is described:

It is set that each UGC skin uses a maximum of 12 float values as custom parameters, and the custom parameters need to be classified into RGB color data and parameter data. For unified management, it is agreed that n color values are first divided from the 12 float values, and the following 12 to 3n float data bits are provided for a parameter that needs to be opened to use. In addition, a skin parameter that is opened to a user needs to have some rules, for example:
orthography, that is, open parameters do not affect control effects of each other; and
high-cost performance, opening of a material parameter has some overhead, whereby the material parameter which has the most significant presentation effect and the highest user demand is to be selected for opening.

Open parameters are classified into the following categories:

### (1) Texture Representation Class

This category mainly includes texture scale (UV Scale). According to a design of a UGC basic skin, when a model is scaled up and scaled down, UV responds to scaling degrees of the model in XYZ axes, to adapt to model scaling.

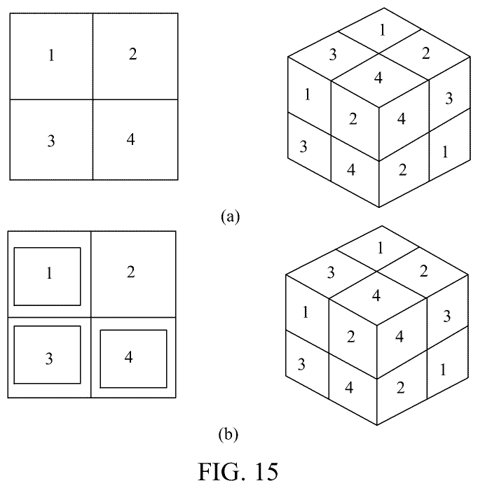

FIG. 15 is a schematic diagram of performing texture scale in different modes. Specific descriptions are as follows:

Using a basic cube as an example, FIG. 15(a) is a mode of UV0, which is expanded according to a cube mapping mode, that is, six surfaces are independently expanded, and a center point of a UV surface is at a position (0.5, 0.5). That is, the center point of the UV face is located at a central position of each surface.

FIG. 15(b) is a mode of UV1, and during expanding, the mode is processed according to the following rules:
Area 3 is passed by an X axis, indicating that this surface responds to scaling of YZ axes.
Area 4 is passed by a Y axis, indicating that this surface responds to scaling of XZ axes.
Area 1 is passed by a Z axis, indicating that this surface responds to scaling of XY axes.
Area 2 cannot be determined, and may be configured for a spherical surface, indicating that this surface responds to scaling of XYZ axis.

Two modes of UV0 and UV1 are combined for use: UV0 matches a skin algorithm, such that when a model is stretched, a texture is scaled from a center. Using a square as an example, textures on two adjacent sides are aligned during scaling, without one moving left and one moving right. UV1 specifies two axes according to which this surface is scaled. In materials, scaling coefficients of a model on the XYZ axes are respectively determined according to magnitudes of three orthogonal unit vectors (1, 0, 0), (0, 1, 0), and (0, 0, 1) after matrix transformation. In addition, a data bit with an Index of 9 is used as a user customizable texture scaling coefficient, and is used as a comprehensive scaling coefficient after being multiplied with a calculated axial scaling coefficient.

### (2) Static Presentation Class

This category mainly controls static representation of a model.

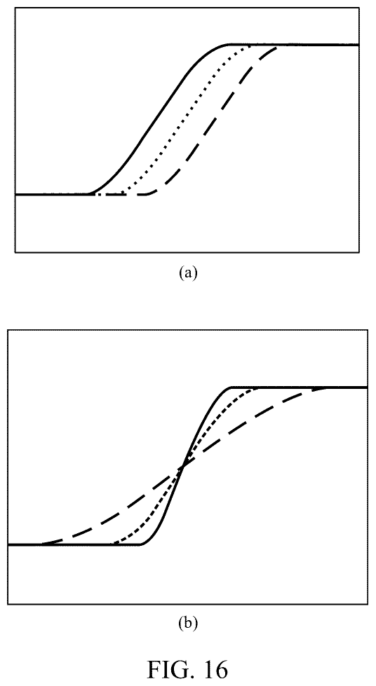

Using a gradient material as an example, values obtained by normalizing lengths on the XYZ axes of the model are used as two custom color gradient parameters. Therefore, a parameter may be used to control whether this gradient parameter is a value of an X axis, a Y axis, or a Z axis, which is referred to as a gradient axial direction. In addition, gradient is implemented by using a SmoothStep function, and an offset and a value range of the gradient parameter may be controlled by using a custom parameter, to control a gradient center and a gradient degree. In some aspects, the three parameters may be provided for the user in a form of custom parameters. For example, Index values are respectively 6, 7, and 8. FIG. 16 is a schematic diagram of controlling a gradient offset and a gradient degree. FIG. 16(a) shows gradient offsets under different parameters, and FIG. 16(b) shows gradient degrees under different parameters.

The Smoothstep function is as follows:

```
float smoothstep (float t1, float t2, float x)
{
  x=clamp((x−t1)/(t2−t1), 0.0, 1.0)
  return x * x * (3−2 * x);
}
```

### (3) Dynamic Presentation Class

This category mainly controls a dynamic presentation effect of a material.

Using a lava rock skin as an example, lava is produced in a mode of using Flowmap. The Flowmap is a two-dimensional texture, and each pixel of the two-dimensional texture describes a direction and a speed of flow. During rendering, the texture is first sampled, original UV is offset according to information recorded by a pixel to obtain FlowUV, and then FinalUV is obtained by solving a difference between the UV and the FlowUV according to a time function, that is, a UV that is finally used for sampling a lava texture. In such an algorithm, two parameters may be provided for a user to adjust. One is a flow speed, and time may be accelerated by multiplying the time by a coefficient, which indicates a higher or lower flow velocity of the lava. The other parameter is a distortion strength, which can make the flow of the lava more apparent. For example, index values of the two parameters are set to 6 and 7.

### (4) Overall Presentation Class

This category mainly controls an overall presentation effect. For example, transparency and emissive intensity.

For a translucent material, transparency is a key to skin presentation of the translucent material. Using a water skin as an example, a relatively high transparency can make water appear clearer, and a relatively low transparency can make the water look more like deep water.

The emissive intensity is an important parameter for an emissive skin, and a relatively high emissive intensity makes a color of the skin diffuse further, which is presented as a relatively strong glow like a neon lamp. A relatively low emissive intensity makes the skin appear relatively dark, and may be used for presenting an old incandescent lamp filament.

### (5) Special Presentation Class

This part mainly includes key presentations of some special skin.

Special skins implemented by various presentation effects occupy a large part of all skins of UGC, and for this part of skins, patterns and light effects required for planning are obtained through various mathematical calculations. Using a gold foil material as an example, circular and hexagonal gold foil spots of the gold foil material are geometric figures calculated in small UV grids on a surface of a model, and corresponding brightness of the grids is calculated according to positions of grid points and a noise function. Some processing is performed on the brightness, and the brightness of the gold foil spots is controlled by using the processed as a mask, which is finally presented controlling density of the gold foil.

Finally, a dynamic change solution in this technical solution is described. A parameter and a target color of the skin may be changed in an editing state, or may naturally be changed according to a group of settings of a user by using interactive input or preset game logic during gameplay. For parameter and color change functions, a UGC element has two states: a residual state and a changing state. Three levels of change logic are abstracted therefrom, which are respectively: a change action, a change sequence, and a change collection. Descriptions are respectively provided below:

### (1) Change Action

The change action is an atomic operation, that is, cannot be logically subdivided. The change action includes two parts: a target state and a switching mode. The target state describes a state that a virtual item needs to achieve after this change action, that is, values of a color and a parameter. The switching mode describes how the virtual item changes from an original state to a target state.

Currently supported switching modes include transition switching and instant switching:
Transition switching: indicating that the virtual item is switched from state A to state B in duration set by a user.
Instant switching: indicating that the virtual item is directly switched from state A to state B, which may correspond to a transition mode with a transition time of 0.

In terms of program implementation, when a switching operation is performed, a UGC virtual item enters a change state, and a parameter and a color are changed according to settings. When a switching mode is the transition switching, duration of a timer is the duration set by the user. When the switching mode is instant switching, the duration is a minimum value. After timing ends, the callback function is executed. In this case, the virtual item enters a residual state, and simultaneously the timer is started. A state of the virtual item is updated after a dwell time ends, to facilitate performing a next change action. When a changing state needs to be forcibly ended, a change process is canceled, and the color and the parameter remain in a current state.

### (2) Change Sequence

The change sequence is a collection of change actions, which sequentially stores all change actions configured in this sequence, and manages execution logic of the change actions. The change sequence includes the following elements:
state: a state of a change sequence, which is invisible to a user;
name: a name of a change sequence, which can be modified by a user;
signal: a trigger execution signal, which can be modified by a user;
priority: a sequence priority, which can be configured by a user;
repeat: whether a sequence may be executed repeatedly;
count: an execution count, which can be modified by a user;
delay: a delayed execution time, which can be modified by a user; and
action list: storing a list of all change actions.

Whether a changer is executed is restricted by a trigger signal and a sequence priority When a signal system transmits a trigger signal corresponding to a current sequence, a state of the sequence is set to be activated, a trigger count is decreased by one, and a change collection is notified to update the state. Sequences of the same priority may interrupt each other. If the execution count of the sequence is less than 0, the sequence is not set to be activated any longer, and the collection is not notified to update any longer.

When a change sequence is activated, a state of the change sequence is updated to an activated state, and after waiting for a delay time configured by the sequence to end, all change actions are sequentially executed from the first change in a change list. After the last action is executed, if the sequence is configured to be repeatedly executed, the first change is restarted; otherwise, a target state of the last change is maintained, and simultaneously the collection is notified to update.

### (3) Change Collection

The change collection stores a plurality of change sequences and manages activation and scheduling between the sequences. One element is included:
sequence list: an ordered list sorted according to priorities of sequences.

When gameplay starts, the change collection finds and activates a first sequence that can be activated according to the order of the sequence list. After that, requests of all sequences are waited to be received, and whether to interrupt a currently activated sequence and execute a new sequence is determined according to a priority.

The technical solutions provided in the embodiments of this disclosure achieve at least the following beneficial effects:

The foregoing technical solutions support a user to set, by editing a skin parameter editing control in at least one changer, a skin change mode of a virtual item in a process of executing the at least one changer, and can preview a skin change effect after the editing, whereby the user can enrich appearance presentations of the virtual item in a game process, fully use existing skin resources of the virtual item, and improve resource utilization. In addition, the user sees a skin change process of the virtual item in real time by using an editing preview area, which avoids a plurality of repeated operations caused by repeated adjustment to achieve a satisfactory skin effect and a plurality of signaling interactions with a terminal device, and improves human-computer interaction efficiency in a process of editing a skin parameter by the user.

The following describes apparatus embodiments of this disclosure, which can be configured to perform the method embodiments of this disclosure. For examples of details not disclosed in the apparatus embodiments of this disclosure, reference can be made to the method embodiments of this disclosure.

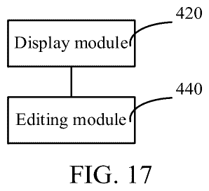

FIG. 17 is a structural block diagram of an information processing apparatus according to an embodiment of this disclosure. The apparatus has a function of implementing the foregoing information processing method examples, and the function may be implemented by hardware or may be implemented by hardware executing corresponding software. As shown in FIG. 17, the apparatus may include: a display module 420 and an editing module 440.

The display module 420 is configured to display a virtual item that is located in a virtual environment and that has a skin in an editing preview area, and display a skin parameter editing control of at least one changer in an editing control area. The changer is configured to edit a skin change process of the virtual item in a game process.

The editing module 440 is configured to edit a skin parameter of at least one target state in the skin change process in response to a parameter editing operation for a skin parameter editing control of the changer.

The display module 420 is configured to display, in the editing preview area, the skin change process of the changer executed on the virtual item,
is the skin being a collection of surface visible attributes of the virtual item.

In some embodiments, the skin parameter of the skin includes at least one of the following: a skin type, the skin type being configured for indicating a type of the skin of the virtual item; and a skin color, the skin color being configured for indicating a color of a skin of the virtual item; an emissive intensity, the emissive intensity being configured for indicating an emissive intensity of the skin in a case that the skin type of the virtual item is an emissive skin; a skin texture, the skin texture being configured for indicating a texture of the skin in a case that the skin type of the virtual item is a textured skin; and a gradient mode, the gradient mode being configured for indicating a gradient effect of the skin in a case that the skin type of the virtual item is gradient skin.

In some embodiments, the skin parameter editing control includes a skin type selection control. The editing module 440 is configured to select a skin type of at least one target state in the skin change process in response to a first selection operation for the skin type selection control of the changer.

In some embodiments, the skin parameter editing control includes a skin color editing control. The editing module 440 is configured to select a skin color of at least one target state in the skin change process in response to a second selection operation for the skin color editing control of the changer.

In some embodiments, the skin parameter editing control includes an emissive intensity editing control. The editing module 440 is configured to edit an emissive intensity of at least one target state in the skin change process in response to a first editing operation for the emissive intensity editing control of the changer.

In some embodiments, the skin parameter editing control includes a skin texture editing control. The editing module 440 is configured to edit a skin texture of at least one target state in the skin change process in response to a second editing operation for the skin texture editing control of the changer, the second editing operation being configured for editing at least one of the following parameters: a texture undulation intensity, a texture undulation quantity, and a texture repetition quantity.

In some embodiments, the skin parameter editing control includes a gradient mode editing control. The editing module 440 is configured to edit a gradient mode of at least one target state in the skin change process in response to a third editing operation for the gradient mode editing control of the changer, the third editing operation being configured for editing at least one of the following parameters: a gradient axial direction, a gradient center, and a gradient intensity.

In some embodiments, the display module 420 is configured to display a virtual item having the skin parameter of the first target state in the editing preview area in response to an editing operation for the skin parameter of the first target state in a case that a preview of the first target state is enabled.

In some embodiments, the display module 420 is configured to display, in the editing preview area in response to a trigger operation on a changer preview control, the skin change process of the changer executed on the virtual item.

In some embodiments, the editing control area further includes at least one of a first dwell time setting control and a second dwell time setting control. The editing module 440 is configured to edit a dwell time of an initial skin of the virtual item in response to an editing operation for the first dwell time setting control, and edit a dwell time of the skin of the at least one target state in response to an editing operation for the second dwell time setting control.

In some embodiments, the editing control area further includes at least one of a first changer setting control, a second changer setting control, and a third changer setting control. The editing module 440 is configured to edit a name of the changer in response to an editing operation for the first changer setting control, edit a trigger condition of the changer in response to an editing operation for the second changer setting control, and edit a repetition count of the changer in response to an editing operation for the third changer setting control.

In some embodiments, the editing control area further includes at least one of a first switching setting control and a second switching setting control. The editing module 440 is configured to: edit, in response to an editing operation for the first switching setting control, a switching mode for switching different skins of the virtual item, where the switching mode includes at least one of instant switching and transition switching; and edit, in response to an editing operation for the second switching setting control, transition duration that the virtual item performs skin switching in the transition switching mode.

In some embodiments, at least two changers are provided. The editing module 440 is configured to adjust priorities of the at least two changers in response to a priority adjustment operation for each changer, the priorities of the at least two changers being configured for indicating an execution sequence of executing the at least two changers in the game process.

In some embodiments, the editing control area includes a trigger signal editing control of the at least one changer. The editing module 440 is configured to set a trigger signal of the at least one changer in response to an editing operation for the trigger signal editing control, the trigger signal being configured for instructing to trigger, in a game process, the virtual item to execute the at least one changer.

In some embodiments, the display module 420 is configured to display, in a case that input content of a trigger signal editing control is not null, a skin change process in which the first changer is executed on the virtual item in the virtual environment in response to receiving a first trigger signal, the first trigger signal being configured for instructing to trigger, in the game process, the virtual item to execute the first changer.

When the apparatus provided in the foregoing embodiments implements functions of the apparatus, division of the foregoing functional modules is merely used as an example for description. In practical applications, the functions may be assigned to different functional modules to complete according to requirements. That is, an internal structure of the device is divided into different functional modules to complete all or some of the functions described above. In addition, the apparatus and method embodiments provided in the foregoing embodiments fall within the same concept. For an example of a specific implementation process, reference can be made to the method embodiments. Details are not described herein again.

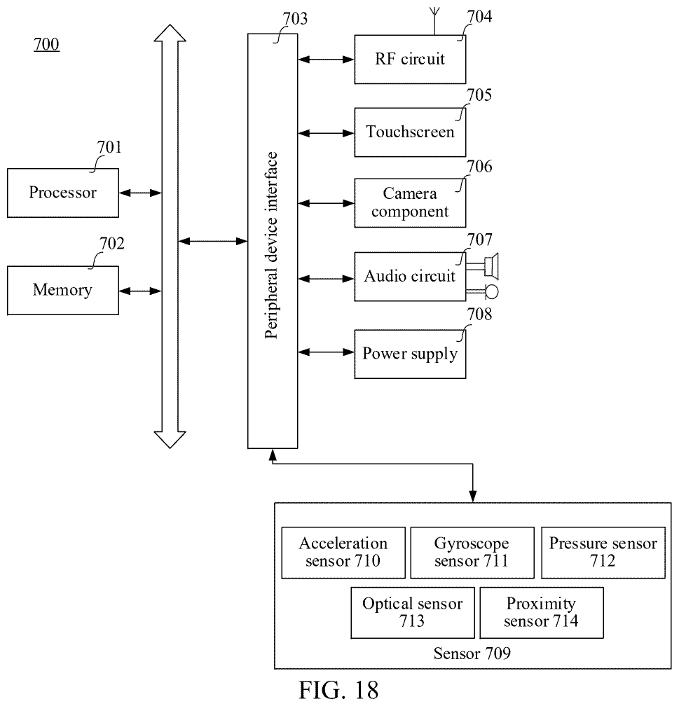

FIG. 18 is a block diagram of a structure of a computer device according to an embodiment of this disclosure.

A computer device 700 may be a portable mobile terminal, which may be referred to as a mobile terminal in this embodiment. For example, a smartphone, a tablet computer, a Moving Picture Experts Group Audio Layer III (MP3) player, or a Moving Picture Experts Group Audio Layer IV (MP4) player. The computer device 700 may be referred to by another name such as a user device and a portable terminal.

In some aspects, the computer device 700 includes processing circuitry, such as a processor 701, and includes a memory 702.

The processor 701 may include one or more processing cores, for example, a 4-core processor or an 8-core processor. The processor 701 may be implemented in at least one hardware form of a digital signal processor (DSP), a field programmable gate array (FPGA), and a programmable logic array (PLA). In some aspects, the processor 701 may include a main processor and a coprocessor. The main processor is a processor configured to process data in an awake state, and may be referred to as a central processing unit (CPU). The coprocessor is a low power consumption processor configured to process data in a standby state. In some embodiments, the processor 701 may be integrated with a graphics processing unit (GPU). The GPU is configured to render and draw content that needs to be displayed on a display screen. In some embodiments, the processor 701 may further include an artificial intelligence (AI) processor. The AI processor is configured to process computing operations related to machine learning.

The memory 702 may include one or more computer-readable storage media. The computer-readable storage media may be tangible and non-transitory. The memory 702 may further include a high-speed random access memory and a nonvolatile memory, for example, one or more disk storage devices or flash storage devices. In some embodiments, a non-transitory computer-readable storage medium in the memory 702 is configured to store at least one instruction, and the at least one instruction is configured to be executed by the processor 701 to implement the method for generating UGC in a game program according to the embodiments of this disclosure.

In some embodiments, the computer device 700 may further include: a peripheral device interface 703 and at least one peripheral device. Specifically, the peripheral device includes at least one of a radio frequency (RF) circuit 704, a touchscreen 705, a camera 706, an audio circuit 707, and a power supply 708.

The peripheral interface 703 may be configured to connect the at least one peripheral related to input/output (I/O) to the processor 701 and the memory 702. In some embodiments, the processor 701, the memory 702, and the peripheral device interface 703 are integrated on the same chip or circuit board. In some other embodiments, any one or two of the processor 701, the memory 702, and the peripheral device interface 703 may be implemented on a single chip or circuit board. This is not limited in this embodiment.

The RF circuit 704 is configured to receive and transmit an RF signal, which may be referred to as an electromagnetic signal. The RF circuit 704 communicates with a communication network and other communication devices through the electromagnetic signal. The RF circuit 704 converts an electric signal into an electromagnetic signal for transmission, or converts a received electromagnetic signal into an electric signal. In some embodiments, the RF circuit 704 includes: an antenna system, an RF transceiver, one or more amplifiers, a tuner, an oscillator, a digital signal processor, a codec chip set, a subscriber identity module card, and the like. The RF circuit 704 may communicate with another terminal by using at least one wireless communications protocol. The wireless communication protocol includes, but is not limited to, a world wide web, a metropolitan area network, an intranet, generations of mobile communication networks (2G, 3G, 4G, and 5G), a wireless local area network and/or a Wi-Fi network. In some embodiments, the RF 704 may further include a circuit related to near field communication (NFC). This is not limited in this disclosure.

The touchscreen 705 is configured to display a user interface (UI). The UI may include a graph, text, an icon, a video, and any combination thereof. The touchscreen 705 further has a capability of collecting a touch signal on or above a surface of the touchscreen 705. The touch signal may be input to the processor 701 as a control signal for processing. The touchscreen 705 is configured to provide a virtual button and/or a virtual keyboard, which may be referred to as a soft button and/or a soft keyboard. In some embodiments, there may be one touchscreen 705, disposed on a front panel of the terminal 700. In some other embodiments, there may be at least two touchscreens 705, respectively disposed on different surfaces of the terminal 700 or designed in a foldable mode. In some other embodiments, the touchscreen 705 may be a flexible display screen, disposed on a curved surface or a folded surface of the terminal 700. Even, the touchscreen 705 may be configured in a non-rectangular irregular pattern, that is, a special-shaped screen. The touchscreen 705 may be prepared by using a material such as a liquid crystal display (LCD), or an organic light-emitting diode (OLED).

The camera component 706 is configured to collect images or videos. In some embodiments, the camera component 706 includes a front camera and a rear camera. In some aspects, the front camera is configured to implement a video call or self-portrait, and the rear camera is configured to shoot a picture or a video. In some embodiments, at least two rear cameras are provided, which are respectively any of a main camera, a depth-of-field camera, and a wide-angle camera to implement a background blurring function by fusing the main camera and the depth-of-field camera, and implement panoramic shooting and virtual reality (VR) shooting functions by fusing the main camera and the wide-angle camera. In some embodiments, the camera component 706 may further include a flash. The flash may be a monochrome temperature flash, or may be a double-color temperature flash. The double-color temperature flash refers to a combination of a warm light flash and a cold light flash, and may be configured for light compensation under different color temperatures.

The audio circuit 707 is configured to provide an audio interface between a user and the computer device 700. The audio circuit 707 may include a microphone and a speaker. The microphone is configured to collect sound waves of a user and an environment, and convert the sound waves into an electrical signal and input the electrical signal to the processor 701 for processing, or input the electrical signal to the RF circuit 704 to implement voice communication. For the purpose of stereo acquisition or noise reduction, there may be a plurality of microphones, respectively arranged at different portions of the computer device 700. The microphone may be an array microphone or an omnidirectional microphone. The speaker is configured to convert the electrical signal from the processor 701 or the RF circuit 704 into sound waves. The speaker may be a film speaker, or may be a piezoelectric ceramic speaker. When the speaker is the piezoelectric ceramic speaker, the speaker can not only convert an electrical signal into acoustic waves audible to human beings, but also can convert an electrical signal into acoustic waves inaudible to human beings, for purposes of ranging and the like. In some embodiments, the audio circuit 707 may further include an earphone jack.

The power supply 708 is configured to supply power to various components in the computer device 700. The power supply 708 may be an alternating current, a direct current, a disposable battery, or a rechargeable battery. When the power supply 708 includes a rechargeable battery, the rechargeable battery may be a wired rechargeable battery or a wireless rechargeable battery. The wired rechargeable battery is a battery charged by using a wired circuit, and the wireless rechargeable battery is a battery charged by using a wireless coil. The rechargeable battery may be configured to support a fast charging technology.

In some embodiments, the computer device 700 further includes one or more sensors 709. The one or more sensors 709 include but are not limited to an acceleration sensor 710, a gyroscope sensor 711, a pressure sensor 712, an optical sensor 713, and a proximity sensor 714.

The acceleration sensor 710 may detect a magnitude of acceleration on three coordinate axes of a coordinate system established with the computer device 700. For example, the acceleration sensor 710 may be configured to detect components of gravity acceleration on the three coordinate axes. The processor 701 may control, according to a gravity acceleration signal collected by the acceleration sensor 710, the touchscreen 705 to display the UI in a landscape view or a portrait view. The acceleration sensor 710 may be configured to collect motion data of a game or a user.

The gyroscope sensor 711 may detect a body direction and a rotation angle of the computer device 700. The gyroscope sensor 711 may cooperate with the acceleration sensor 710 to collect a three-dimensional (3D) action of the user on the computer device 700. The processor 701 may implement the following functions according to the data collected by the gyroscope sensor 711: motion sensing (for example, changing the UI according to a tilt operation of the user), image stabilization during shooting, game control, and inertial navigation.

The pressure sensor 712 may be disposed on a side frame of the computer device 700 and/or a lower layer of the touchscreen 705. When the pressure sensor 712 is disposed on the side frame of the computer device 700, a holding signal of the user on the computer device 700 may be detected, and left and right hand recognition or a quick operation may be performed according to the holding signal. When the pressure sensor 712 is disposed on the low layer of the touchscreen 705, an operable control on the UI may be controlled according to a pressure operation of the user on the touchscreen 705. The operable control includes at least one of a button control, a scroll-bar control, an icon control, and a menu control.

The optical sensor 713 is configured to collect ambient light intensity. In an embodiment, the processor 701 may control the display brightness of the touchscreen 705 according to the ambient light intensity collected by the optical sensor 713. Specifically, when the ambient light intensity is relatively high, the display brightness of the touchscreen 705 is increased. When the ambient light intensity is relatively low, the display brightness of the touchscreen 705 is decreased. In another embodiment, the processor 701 may further dynamically adjust a shooting parameter of the camera component 706 according to the ambient light intensity collected by the optical sensor 713.

The proximity sensor 714, which may also be referred to as a distance sensor, may be disposed on a front surface of the computer device 700. The proximity sensor 714 is configured to collect a distance between the user and the front surface of the computer device 700. In an embodiment, when the proximity sensor 714 detects that the distance between the user and the front surface of the terminal 700 decreases gradually, the touchscreen 705 is controlled by the processor 701 to switch from a screen-on state to a screen-off state. When the proximity sensor 714 detects that the distance between the user and the front surface of the terminal 700 increases gradually, the touchscreen 705 is controlled by the processor 701 to switch from the screen-off state to the screen-on state.

A person skilled in the art may understand that the structure shown in FIG. 18 does not constitute a limitation to the computer device 700, more components or fewer components than those shown in the figure may be included, or some components may be combined, or a different component deployment may be used.

In an embodiment, this disclosure provides a chip. The chip includes a programmable logic circuit and/or program instructions. The chip is configured to, when running on a computer device, implement the information processing method according to the foregoing method embodiments.

This disclosure provides a non-transitory computer-readable storage medium. The non-transitory computer-readable storage medium has a computer program or instructions stored thereon, and the computer program or instructions are loaded and executed by a processor to implement the information processing method according to the foregoing method embodiments.

This disclosure provides a computer program product or a computer program. The computer program product or the computer program includes computer instructions, and the computer instructions are stored in a non-transitory computer-readable storage medium. A processor of a computer device reads the computer instructions from the non-transitory computer-readable storage medium, and executes the computer instructions, which enables the processor of the computer device to load and execute the information processing method according to the foregoing method embodiments.

The numbers in the foregoing embodiments of this disclosure are merely for description, and do not limit the embodiments.

A person of ordinary skill in the art may understand that all or some steps of the foregoing embodiments may be implemented by hardware, or may be implemented by a program instructing relevant hardware. The program may be stored in a non-transitory computer-readable storage medium. The non-transitory computer-readable storage medium mentioned above may be a read-only memory, a magnetic disk, an optical disc, or the like.

Those skilled in the art will be aware that in the foregoing one or more examples, functions described in the embodiments of this disclosure may be implemented by hardware, software, firmware, or any combination thereof. When implemented by using software, these functions can be stored in a non-transitory computer-readable medium or transmitted as one or more instructions or code in the non-transitory computer-readable medium. The non-transitory computer-readable medium may be any available medium accessible to a general-purpose or dedicated computer.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The foregoing descriptions are merely non-limiting embodiments of this disclosure, and are not intended to limit this disclosure. Any modification, equivalent replacement, improvement, or the like falls within the scope of this disclosure.

What is claimed is:

1. An information processing method, comprising:
displaying, by processing circuitry in an editing preview area of a user generated content (UGC) editing interface of a game program based on execution of the game program, a virtual object in a virtual environment, a skin of the virtual object corresponding to a collection of surface visible attributes of the virtual object;
displaying, by the processing circuitry in an editing control area of the UGC editing interface, at least one changer configured to define a skin change process of the skin of the virtual object in a game process;
setting a skin parameter corresponding to one of the surface visible attributes of at least one target state in the skin change process based on a parameter editing operation of a skin parameter editing control element of the changer; and
displaying, in the editing preview area, the virtual object based on execution of the skin change process defined by the changer.

2. The method according to claim 1, wherein the skin parameter corresponds to one or more attributes including:
a skin type indicating a type of the skin of the virtual object;
a skin color indicating a color of the skin of the virtual object;
an emissive intensity indicating an emissive intensity of the skin when the skin type of the virtual object is an emissive skin;
a skin texture indicating a texture of the skin when the skin type of the virtual object is a textured skin; or
a gradient mode indicating a gradient effect of the skin when the skin type of the virtual object is a gradient skin.

3. The method according to claim 1, wherein
the skin parameter editing control element includes a skin type selection control element, and
the setting the skin parameter includes:
selecting a skin type of the at least one target state in the skin change process based on a first selection operation for the skin type selection control element.

4. The method according to claim 1, wherein
the skin parameter editing control element includes a skin color editing control element, and
the setting the skin parameter includes:
selecting a skin color of the at least one target state in the skin change process based on a second selection operation of the skin color editing control element.

5. The method according to claim 1, wherein
the skin parameter editing control element includes an emissive intensity editing control element, and
the setting the skin parameter includes:
setting an emissive intensity of the at least one target state in the skin change process based on a first editing operation of the emissive intensity editing control element.

6. The method according to claim 1, wherein
the skin parameter editing control element includes a skin texture editing control element, and
the setting the skin parameter includes:
setting a skin texture of the at least one target state in the skin change process based on a second editing operation of the skin texture editing control element,
the second editing operation corresponding to setting one or more parameters including: a texture undulation intensity, a texture undulation quantity, or a texture repetition quantity.

7. The method according to claim 1, wherein
the skin parameter editing control element includes a gradient mode editing control element; and
the setting the skin parameter includes:
setting a gradient mode of the at least one target state in the skin change process based on a third editing operation of the gradient mode editing control element,
the third editing operation corresponding to setting one or more parameters including: a gradient axial direction, a gradient center, or a gradient intensity.

8. The method according to claim 1, further comprising:
displaying the virtual object having the skin parameter of a first target state of the at least one target state in the editing preview area based on the parameter editing operation corresponding to the setting of the skin parameter of the first target state, when a preview of the first target state is enabled.

9. The method according to claim 1, wherein the displaying the virtual object based on the execution of the skin change process comprises:
displaying, in the editing preview area based on a trigger operation on a changer preview control element, the virtual object based on the execution of the skin change process.

10. The method according to claim 1, wherein
the editing control area includes at least one of a first dwell time setting control element or a second dwell time setting control element, and
the method further comprises one or more of:
setting a first dwell time of an initial skin of the virtual object based on an editing operation of the first dwell time setting control element; or
setting a second dwell time of the skin of the at least one target state based on an editing operation of the second dwell time setting control element.

11. The method according to claim 1, wherein
the editing control area includes at least one of a first changer setting control element, a second changer setting control element, or a third changer setting control element, and
the method further includes at least one of:
setting a name of the changer based on an editing operation of the first changer setting control element;
setting a trigger condition of the changer based on an editing operation of the second changer setting control element; or
setting a repetition count of the changer based on an editing operation of the third changer setting control element.

12. The method according to claim 1, wherein
the editing control area includes at least one of a first switching setting control element or a second switching setting control element; and
the method further includes at least one of:
setting, based on an editing operation of the first switching setting control element, a switching mode of switching different skins of the virtual object, the switching mode including instant switching or transition switching; and
setting, based on an editing operation of the second switching setting control element, a transition duration that the virtual object performs skin switching in the transition switching mode.

13. The method according to claim 1, wherein
the at least one changer corresponds to two or more changers, and
the method further includes:
adjusting priorities of the two or more changers based on a priority adjustment operation of each changer of the two or more changers, the priorities of the two or more changers indicating a sequence of an execution of each of the two or more changers in the game process.

14. The method according to claim 1, wherein
the editing control area includes a trigger signal editing control element of the at least one changer, and
the method further includes:
setting a trigger signal of the changer based on an editing operation of the trigger signal editing control element, the trigger signal instructing a triggering of the execution of the skin change process defined by the changer in the game process.

15. The method according to claim 1, further comprising:
displaying, when input content of a trigger signal editing control element of the changer is not null, the virtual object based on the execution of the skin change process defined by the changer when a trigger signal is received, the trigger signal indicating a triggering of the execution of the skin change process defined by the changer.

16. The method according to claim 1, wherein
a priority of a trigger signal that is received later is higher than a priority of another trigger signal that is received earlier, and
the trigger signal and the another trigger signal correspond to two different trigger signals.

17. An information processing apparatus, comprising:
processing circuitry configured to:
display, in an editing preview area of a user generated content (UGC) editing interface of a game program based on execution of the game program, a virtual object in a virtual environment, a skin of the virtual object corresponding to a collection of surface visible attributes of the virtual object;
display, in an editing control area of the UGC editing interface, at least one changer configured to define a skin change process of the skin of the virtual object in a game process;
set a skin parameter corresponding to one of the surface visible attributes of at least one target state in the skin change process based on a parameter editing operation of a skin parameter editing control element of the changer; and
display, in the editing preview area, the virtual object based on execution of the skin change process defined by the changer.

18. The apparatus according to claim 17, wherein the skin parameter corresponds to one or more attributes including:
a skin type indicating a type of the skin of the virtual object;
a skin color indicating a color of the skin of the virtual object;
an emissive intensity indicating an emissive intensity of the skin when the skin type of the virtual object is an emissive skin;
a skin texture indicating a texture of the skin when the skin type of the virtual object is a textured skin; or
a gradient mode indicating a gradient effect of the skin when the skin type of the virtual object is a gradient skin.

19. The apparatus according to claim 17, wherein, to display the virtual object based on the execution of the skin change process, the processing circuitry is configured to:
display, in the editing preview area based on a trigger operation on a changer preview control element, the virtual object based on the execution of the skin change process.

20. A non-transitory computer-readable storage medium storing instructions, which when executed by a processor, cause the processor to perform:
displaying, in an editing preview area of a user generated content (UGC) editing interface of a game program based on execution of the game program, a virtual object in a virtual environment, a skin of the virtual object corresponding to a collection of surface visible attributes of the virtual object;
displaying, in an editing control area of the UGC editing interface, at least one changer configured to define a skin change process of the skin of the virtual object in a game process;
setting a skin parameter corresponding to one of the surface visible attributes of at least one target state in the skin change process based on a parameter editing operation of a skin parameter editing control element of the changer; and
displaying, in the editing preview area, the virtual object based on execution of the skin change process defined by the changer.
